(19) United States
(12) Patent Application Publication
(10) Pub. No.: US 2024/0408795 A1
(43) Pub. Date: Dec. 12, 2024

(54) Extruder Systems and Processes Thereof

(71) Applicant: ExxonMobil Technology and Engineering Company, Baytown, TX (US)

(72) Inventors: Mallerie D. McCune, Houston, TX (US); Paul T.Q. Nguyen, League City, TX (US); Edward J. Blok, Huffman, TX (US); Ronald Deyoung, Waesifield Center, OH (US); Jianya Cheng, King wood, TX (US)

(21) Appl. No.: 18/699,445

(22) PCT Filed: Oct. 18, 2022
(86) PCT No.: PCT/US2022/046952

§ 371 Date: Apr. 8, 2024

Related U.S. Application Data
(60) Provisional application No. 63/273,514, filed on Oct. 29, 2021.

(51) Int. Cl. B29B 7/48; B29B 7/60; B29B 7/84; B29B 9/02; B29K 23/00; B29K 105/00; B29L 30/00; B60C 1/00; C08F 8/42

(52) U.S. Cl. CPC B29B 7/48; B29B 7/60; B29B 7/845; B60C 1/0016; C08F 8/42; B29B 9/02; B29K 2023/16; B29K 2023/22; B29K 2105/0005; B29L 2030/002

(57) ABSTRACT

The present disclosure relates to a method of forming a composition including forming a polymer melt in a melt feeder. The melt feeder is coupled with an extruder. The method includes introducing the polymer melt from the melt feeder to the extruder at a first location of the extruder. The method includes extruding the polymer melt through the extruder via a plurality of intermeshing screws disposed within the extruder. The method includes introducing a coupling agent to the extruder at a second location of the extruder.

### CROSS REFERENCE TO RELATED APPLICATIONS

This application claims priority to and the benefit of U.S. Provisional Application No. 63/273,514, filed Oct. 29, 2021, the disclosure of which is incorporated herein by reference in its entirety.

### FIELD

The present disclosure relates to extruder systems and processes thereof.

### BACKGROUND

Monoolefin rubber, such as butyl rubber and terpolymers (of ethylene, propylene, and a minor portion of diene monomer (EPDM rubber)) have advantageous properties but can nonetheless have poor tack properties and can be consequently unsuited to the production of built-up molded articles, such as tires where assembly of uncured components desires good tack.

Blends of EPDM or butyl rubber with high-diene rubber (e.g., natural rubber) appeared to be the answer to the search for a rubbery material which could combine the good properties of each of EPDM and high-diene rubber. Unfortunately, simple blends of these two materials (high-diene rubber with EPDM or butyl rubber) have not proved to be successful, except those in which only a small amount of one or the other type of rubber was present. Thus, the mixtures result in heterogeneous mixtures with poor properties.

As an example, the various methods of attempting to resolve this incompatibility between EPDM and high diene rubber have all left something to be desired. Such methods include 1) using special vulcanization systems and special accelerators to try to achieve optimum vulcanization of both phases, 2) making EPDM rubber with significantly higher diene content, 3) modifying prevulcanizing EPDM rubber before blending high-diene hydrocarbon rubber with it. All of these methods have produced some improvements in the properties of the blends, but the improvements were not sufficient to justify their cost. Accordingly, a blend of EPDM and high-diene rubber which would have the good properties of each component is still unrealized in the industry.

Attempts have been made to functionalize one or more of the butyl rubber, EPDM, or high diene rubber. Indeed, functionalized polymers in general are used in many desired end use applications. However, forming functionalized polymers with control of desired properties is difficult, particularly while using a batch mixer. For example, the larger the batch mixer size, the harder it is to control the batch temperature (reaction). It is also much more difficult to control the end of the reaction in a batch process, as thick slabs of rubber are difficult to cool.

There is a need for improved methods of providing functionalized polymers that, for example, provide good properties when used in blends.

References for citing in an information disclosure statement (37 C.F.R. 1.97(h)): U.S. Pat. No. 6,279,633; U.S. Pub. No. 2020/0247009; U.S. Pat. No. 6,539,996; U.S. Pub. No. 2017/0015911; U.S. Pat. Nos. 7,655,728; 7,423,089; 10,882,981; WO 2019/226843; WO2021/126625.

### SUMMARY

The present disclosure relates to extruder systems and processes thereof.

In at least one embodiment, a method of forming a composition includes forming a polymer melt in a melt feeder. The melt feeder is coupled with an extruder. The method includes introducing the polymer melt from the melt feeder to the extruder at a first location of the extruder. The method includes extruding the polymer melt through the extruder via a plurality of intermeshing screws disposed within the extruder. The method includes introducing a coupling agent to the extruder at a second location of the extruder.

In at least one embodiment, an extruder system includes an extruder having a first end, a second end, and a plurality of ports disposed along the extruder. The extruder system includes a rubber feeder coupled with the first end of the extruder or a first port of the plurality of ports. The extruder system includes a vent stuffer coupled with a second port of the plurality of ports. The extruder system includes an additive source coupled with a third port of the plurality of ports. The extruder system includes a coupling agent source coupled with a fourth port of the plurality of ports. The extruder system includes a melt pump coupled with the second end of the extruder.

### BRIEF DESCRIPTION OF THE FIGURES

To assist those of ordinary skill in the relevant art in making and using the subject matter hereof, reference is made to the appended figures, wherein:

FIG. 1 is an NMR Spectrum of a silane-functionalized EPDM rubber, according to an embodiment.

FIG. 2 is an NMR Spectrum of a silane-functionalized butyl rubber, according to an embodiment.

### DETAILED DESCRIPTION

The present disclosure relates to extruder systems and processes thereof. The issues discussed above (e.g., regarding a batch reactor) may be overcome via a reactive extrusion process of the present disclosure. High throughputs can be achieved on a reactive extrusion continuous process with much more control of shear and temperatures along with variable shear and temperature zones. The higher mixing intensity and high degree of surface renewal are ideal for sulfur grafting on to the selected polymers. Cooling is also much more uniform with a reactive extrusion process as small pellets may be formed in an underwater pelletization process vs. dropping on a mill and then going into a water tray for the batch process. Indeed, improved extrusion methods and extruder systems are provided that are capable of providing functionalized polymers in an economical process.

In at least one embodiment, a method of forming a composition includes forming a polymer melt in a melt feeder. The melt feeder is coupled with an extruder. The method includes introducing the polymer melt from the melt feeder to the extruder at a first location of the extruder. The method includes extruding the polymer melt through the extruder via a plurality of intermeshing screws disposed within the extruder. The method includes introducing a coupling agent to the extruder at a second location of the extruder.

In at least one embodiment, an extruder system includes an extruder having a first end, a second end, and a plurality of ports disposed along the extruder. The extruder system includes a rubber feeder coupled with the first end of the extruder or a first port of the plurality of ports. The extruder system includes a vent stuffer coupled with a second port of the plurality of ports. The extruder system includes an additive source coupled with a third port of the plurality of ports. The extruder system includes a coupling agent source coupled with a fourth port of the plurality of ports. The extruder system includes a melt pump coupled with the second end of the extruder.

In addition, one non-limiting application of functionalized polymers is the use of the polymers as a tire tread additive. One of the technical challenges for tire tread is to deliver excellent traction, low rolling resistance while providing good tread wear. Tire tread compounds in a tire dictate properties of the tire, such as wear, traction, and rolling resistance. The challenge lies in the trade-off between wet traction and rolling resistance/tread wear. For example, providing better wet traction (e.g., by raising a tire tread compound's glass transition temperature) at the same time increases the rolling resistance and tread wear.

Functionalized polymers (e.g., for use as tire tread additives) can be formed in an extruder in a batch method. Currently, this reactive extrusion process is based on a rubber blend feed involving granulation of rubber, two steps of batch blend mixing, and then to rubber blend feeding (overall, a “batch” process). The rubber blend feed technique involves use of a filler, such as clay or talc, to ensure that the granulated rubber does not agglomerate and stick to the granulator blades, which would otherwise cause damage to the extruder. However, the presence of filler in the tire tread has a negative impact on tire performance, such as cracking initiation and propagation.

However, a rubber feeder of the present disclosure can provide a polymer (e.g., rubber) melt to the extruder, reducing or eliminating a need for filler to be introduced to the ultimate tire product. The reduction or absence of filler in the tire product provides improved wear resistance, for example reduced or eliminated cracking initiation and propagation, of the tire product (tire tread). Use of a rubber feeder also reduces or eliminates a need to granulate rubber before introducing the rubber to the extruder. In addition, use of a rubber melt provided to the extruder provides a continuous and smooth flow stream of rubber to the extruder which provides a consistent, uniform composition (and tire product) to be formed in the extruder. In contrast, use of granulated rubber as a feed to an extruder can provide less consistent composition and/or morphology of tire products.

In addition, a conventional tire tread compound can continue to cross-link inside the journal bearing gap if a melt gear pump is used at the terminus of the extruder, and thus the bearings can seize up if there is too much cross-linking of the tire tread compound. Hence, it would be expected that a highly cross-linked material would be formed in the extruder (effectively clogging the extruder with thermoset material). However, the inventors have discovered that this did not occur. For example, processes and extruder systems of the present disclosure can break disulfide bonds (e.g., crosslinking) that do form in the extrudate and provide compositions (and tire products) having very fine morphology. Breaking the bonds that promote crosslinking assists with forming a composition of the present disclosure that has low gel content, for example a gel content of about 20% to about 50%. For example, a gel can be a soft gel (instead of a hard gel) and might not form until a composition is out of the extruder and is in a downstream pelletizer. In addition, use of a coupling agent that is a silane coupling agent in a process of the present disclosure can provide a high degree of functionalization of a polymer of the polymer melt. A high degree of functionalization provides similar polarity between, for example, a functionalized EPDM or functionalized butyl with highly unsaturated SBR, BR, and NR. The improved similarity of polarity (via increased degree of functionalization) provides improved wet braking, rolling resistance, and maintains wear performance when the functionalized polymer is used as a tire tread additive in a tire product of the present disclosure. A silane coupling agent can provide low amount of crosslinking in an extrudate/composition of the present disclosure, as compared to use of sulfur. In addition, a low amount of crosslinking provides reduced or eliminated shutdown of the extruder system and little or no need for a downstream process that breaks crosslinking of a composition of the present disclosure.

In addition, use of a twin screw melt pump disposed at the outlet of the extruder provides reduced or eliminated reaction (e.g., cross-linking) of functionalized polymer downstream of the extruder, which can otherwise occur in conventional melt gear pumps where product flows through a gap of journal bearings. As a consequence, excessive cross-linking would otherwise form a product (thermoset material) that cannot flow through a conventional single screw melt gear pump. In addition, excessive cross-linking forms gels inside a melt gear pump which plugs the pump and reduces the quality of the composition (and tire product) that is formed. However, a melt pump of the present disclosure (disposed at an outlet of the extruder) can have a twin screw design that provides reduced or eliminated reaction of the extrudate downstream of the extruder and/or provides sufficient flow of reacted material through the melt pump, in contrast to conventional melt gear pumps.

Overall, extruder systems and processes of the present disclosure provide functionalized polymers (via reactive extrusion) (e.g., as tire tread additives) and compositions (and tire products) having improved wet traction and rolling resistance while maintaining wear resistance performance.

For purposes of the present disclosure, when a polymer is referred to as comprising an olefin, the olefin present in the polymer is the polymerized form of the olefin, respectively. Likewise the use of the term polymer is meant to encompass homopolymers and copolymers, where copolymers include any polymer having two or more chemically distinct monomers.

For the purposes of this disclosure, the term “polypropylene” as used herein means polymers containing propylene as monomers, it can be homopolypropylene or copolymer of propylene and α-olefin comonomers.

For the purposes of this disclosure, the term “polyethylene” as used herein means polymers containing ethylene as monomers, it can be homopolyethylene or copolymer of ethylene and α-olefin comonomers.

As used herein, a “composition” can include the components of the composition and/or one or more reaction product(s) of the components.

As used herein, a “tire product”, also referred to as “tire tread” is a composition of the present disclosure that has been shaped to resemble at least a portion of a tire.

An apparatus for functionalization of polymers (e.g., rubber) can include an extruder and a rubber feeder coupled with the extruder. The apparatus includes a vent stuffer coupled with the extruder and an additive source coupled with extruder. The apparatus includes a coupling agent source coupled with the extruder. The extruder is coupled, via a conduit, at a second end with a first end of a melt pump. The melt pump is coupled at a second end, via a conduit, to a first end of an extrusion die.

The additive source provides one or more additives, such as an antioxidant and/or carbon material, to the extrudate being extruded through extruder.

A coupling agent source coupled with the extruder provides one or more coupling agents, such as a silane, to the extrudate being extruded through extruder. The coupling agent may be added as a solid to the extruder, providing easier feeding as compared to a liquid coupling agent.

A vent stuffer can be any suitable vent stuffer, such as a twin screw vent stuffer, which can be commercially available from Coperion GmbH of Stuttgart, Germany. For example, it may be desirable to remove air from the feed/melt to ensure the melt flows through the extruder, exits the extruder, and enters into the melt pump substantially free of air bubbles. Such air bubbles can form voids in the extruded product and weaken its structure. It may also be desirable to remove moisture from the feed/melt to remove water content from the melt which would otherwise hydrolyze the coupling agent (e.g., silane), the hydrolysis of which promotes gel formation in the functionalized polymer product. Thus, a vacuum can be applied to a portion of extruder. The vacuum is applied through the vent stuffer in a manner that prevents material from migrating through the vacuum port while also preventing clogging of the port. The level of vacuum applied to the extruder via the vent stuffer, and location of the vacuum along the extruder, can be varied to achieve a desired degree of de-airing and/or moisture removal. An additional vent can be coupled with the extruder and is disposed upstream of the rubber feeder to provide additional de-airing and/or moisture removal. The vent may be an ambient vent or a vacuum vent. In some embodiments, a vent stuffer and additional vent of the present disclosure are coupled with a first portion (e.g., the initial ⅛ to ½ of the length, such as ¼ of the length) of the extruder.

Screws used in the extruder are intermeshing and co-rotating screws.

An extruder of the present disclosure can have any suitable number of ports, number of screws, number of barrels, barrel lengths, arrangements of solid barrels and combination barrels, depending on processing parameters used. One more screws can be blocking screws. Blocking screws can be designed to prevent the cross-over of material from one portion of the extruder to another portion of the extruder. Blocking screws may be static or can be solid and rotating. The terms “initial” and “remainder” are used with reference to the direction an extrudate flows through the extruder.

A screw of the present disclosure can include 54 elements and 19 flow zones. Transitioning the extrudate from one flow zone to the next flow zone is defined as leaving a conveying zone and entering a mixing zone, or leaving a mixing zone and entering a conveying zone.

The elements of a screw (e.g., the 54 elements of a non-limiting example screw) can be classified as one of a conveying element, a kneader, a back flow element, a flow splitter, or a restrictive conveying element. In some embodiments, a screw of the present disclosure comprises one or more conveying element, one or more kneader, one or more back flow element, one or more flow splitter, one or more restrictive conveying element, or combination(s) thereof in any suitable configuration. Conveying elements are fluted screws of various pitches that are designed to move the extrudate forward in the mixing barrel. Kneaders tend to restrict the flow of the extrudate, and the kneaders provide extreme shearing, particle size reduction, and heat generation. Back flow elements are fluted to reverse the flow of the extrudate, and act as restricting or blocking elements. Restrictive conveying elements can be single flight elements with wide crest or those with slotted flighting which kneads the extrudate as it is conveyed forward. Restrictive conveying elements can have low pitched flights or high pitched flights with slots.

The screw elements are described commercially in their design by letter and number designations. The number and letter designations and the screw elements are available from Century Extruders, Traverse City, Mich.

S and SK refer to conveying elements which do some mixing, but are used mainly to push material in the extruder from the rubber feeder end to the extruding end. The SK elements are conveying elements with a higher free volume than regular conveying elements, and are used as transition elements between flow zones. SG refers to elements that convey the extruding material while providing substantial mixing.

KB refers to kneading elements. The kneaders do not have a large bias toward moving the extruding material forward, and tend toward filling with material from upstream in the extruder. The kneaders may comprise any number of plates that may have one or more points. For example, a two point kneading plate has a generally parallelogram shape with two points corresponding to the maximum diameter of the plate, and a three point plate has three similar maximum diameter points and three corresponding flat areas with a diameter close to the diameter of the screw shaft. When a back flow conveyer is used in conjunction with a kneader, filling of the flow zone around the kneader is assured, and the increased pressure and shearing caused by the filling has a tendency to dramatically increase the temperature of the extruding material.

Numbers in the screw element designations refer to the pitch of the flutes, the length of the element and the number of plates in the element. Additional letters refer to their orientation left (L) or right (R) and their type. In the description, the letter ‘N’ denotes that the elements are ‘neutral’, and provide no conveying action in either direction.

S060R030, for example, refers to a conveying element (S), having a flute pitch of 060 mm to the right (R), and having a length of 30 mm. Similarly, KBS405R030 refers to a kneader (KBS) having a separation of 45° between adjacent plate tips, five plates with a right hand conveying bias, and a length of 30 mm. S040RL040 Igel and KBS905N030 are flow splitting elements that cut the extruding flow into two or more streams, and directs the divided streams left (L) and right (R) back upon themselves. These flow splitting elements cause a crossover between the inner and outer extrudate streams. S030L015 refers to a back flow conveying element having a pitch of 30 mm to the left (L), and a length of 15 mm. The L designation describes the pitch direction of the fluting as tending to push the extruding material back toward the feed throat, sometimes referred to as reverse flow.

The back flow elements, the kneaders and other non-conveying or low conveying elements, cause a build up of pressure in their particular flow zones, until the pressure of feeding material and the pressure caused by the upstream conveying elements overcomes the back pressure, and forces the extruding material through the respective flow zone.

In the embodiments, back flow elements, when they are used, are at the end of a flow or mixing zone. Since the back flow elements create a dam, it is deemed that they define the end of a flow zone. Similarly, since a restrictive conveying element produces high pressure in its flow zone, the end of such an element, where the pressure is released into a forward conveying element, is considered to be the end of a flow zone.

The function of each flow zone can be defined by its shear rate, and the number of shears carried out in the flow zone. The kneaders and flow splitters, for example, are used for melting and increasing the temperature of the extrusion, in addition to the mixing they provide, and are designed to produce a large number of shears. The conveying elements provide some mixing, but are designed mainly to move the extrusion along, and do not produce as many shears as the kneaders. Most of the other mixing elements fall somewhere between the kneaders and the conveying elements in their mixing capability and their shearing capability.

As illustrated in U.S. Pat. No. 4,594,390, shear rate is defined by C×RPM/tip clearance (where the ‘tip clearance’ is the distance between the tip of the screw and the wall of the extruding chamber (e.g., mixing barrel)), and C is the circumference of the element. In other words, the shear rate is the tip velocity divided by the tip clearance. The number of shears, therefore, is the ‘shear rate’×‘the length of the particular flow zone’, and the shear rate is directly related to the mixing aggressiveness of a particular screw profile. In processes of the present disclosure, shear rates of 400 sec⁻¹ or greater can be effectively used.

There is substantial shearing between the tips of the screws and the bottom of the grooves of adjacent intermeshing screws, and the prior calculations do not completely describe the mixing process, and for the purposes of the present disclosure, the mixing ability of a particular screw profile may be described in terms of the ‘meshes’ of the screw, and the ‘intermeshes’ of a plurality of intermeshing screws. As used herein, ‘meshes’ refers to the mixing potential of a particular screw element or profile, and ‘intermeshes’ refers to the mixing potential of a plurality of intermeshing screws.

The number of shears created by a specific screw element is dependent on the profile of that element, and the number of shears created between the screw tips and the mixing barrel will be an inherent property of the element profile, and the calculation of the meshes and intermeshes of the screws is a more satisfactory method of determining a screw profile's processing ability than the methods described in the prior art.

During processing, when the screws are rotating at a specific RPM, the number of intermeshes/sec, or intermeshes sec⁻¹, can be calculated, as a measure of the amount of mixing taking place in the extrudate. The amount of mixing that goes into the processing of a particular extrudate further depends on the feed rate of the materials, the RPM of the extruder screws, the viscosity ratio and temperature of the materials, their surface wetting properties, the surface tension of the particles, and their flow characteristics.

The FCA is the free cross sectional area in cm² that exists between the screw elements, the barrel surface and the core. Material feeding rate into the extruder is specified on the basis of FCA. For example, in a 30 mm extruder the FCA as provided by the vendor is 26.2 cm². At 400 RPM and 200 kg/Hr rate, the material feeding rate=(200 kg/Hr)/(26.2 cm²)=7.63 kg/(Hr×cm²) and at 100 RPM and 50 kg/Hr, the material feeding rate=(50 kg/Hr)/(26.2 cm²)=1.91 kg/(Hr×cm²).

In practice, often the rate, screw speed, barrel temperature and other process conditions are optimized to get target product properties at scale-up. For similar quality in scale-up, it may be important to maintain similar residence time, melt temperature, cure and mixing profile along screw axis on different size extruders. In some embodiments, an extrusion is performed at an extruder temperature (e.g., internal temperature of the barrel) of about 100° F. to about 700° F., such as about 200° F. to about 650° F., such as about 150° F. to about 600° F., such as about 150° F. to about 400° F., such as about 200° F. to about 300° F.

The rate for scale-up at same screw speed can be calculated by multiplying the material feeding rate for the known extruder with the FCA for the desired or target extruder and the diameter ratio of the target and the known extruder. This is further illustrated for the example where rate for a 50 mm extruder is calculated from the data from the 30 mm size equipment at 400 RPM.

$${Rate}_{50 mm} ( kg / hr ) = {( material feeding rate ( kg / ( hr \times {cm}^{2} ) ) )}_{30 mm} \times F C {A}_{50 mm} \times 50 mm / 30 = 7 \text{.63}$$

$$kg / ( hr \times {cm}^{2} ) \times 74.1 {Cm}^{2} \times 1.67 = 944 kg / hr .$$

The significant parameters that define the mixing imparted by the extruder in the process are related in the following manner: the degree of mixing is a function of the No. of Tips factor, Pitch factor, Length or L/D factor, Restriction factor, Free Cross-Sectional Area (FCA), RPM and Rate.

Independent of the materials used, the meshes per second in a particular flow zone can be found by multiplying the Restriction Factor, times a length factor, times a pitch factor, times a number of tips factor times the number of revolution per second. The number of intermeshes/sec can be found by multiplying the resulting number by the number of screws used in the extrusion.

Screws of the present disclosure may have 250 to 820 meshes, such as 300 to 800 meshes, such as 340 to 745 meshes. Screws may have about 10 to 14 meshes per L/D, where meshes per L/D is calculated by dividing the meshes for a given screw design with its L/D.

For the purposes of the present disclosure, a flow zone or a mixing zone can be further defined as a set of one or more mixing elements or a set of one or more conveying elements. End point of each zone is defined by the transition from conveying to mixing elements or vice versa. For example S060R060 followed by S060R030 will be one zone. However, S060R060 followed by SE010R030, or any other mixing element, defines a separation between two different zones. Accordingly, if all 0.5 L/D mixing and conveying elements are used, theoretically a screw of 100 L/D can have 200 mixing zones. Those skilled in the art will recognize that larger diameter machines can use screw elements having <0.5 L/D.

In an effort to quantify the mixing properties of a particular screw profile, Restriction Factors have been assigned to each of the elements used in a screw profile, based on a mixing factor determined by the number of plates, shears and contact area (e.g. restrictive conveying elements have a shorter pitch and higher residence times, and the pressure in the zone is increased), and their function (such as reverse flow), and the radial clearance of the tips between the barrel or an adjacent screw element.

Restriction Factors assigned for specific screw elements are given in Table 1.

TABLE 1

| Screw | Restriction Factor |
|---|---|
| FC = Forward Convey (R) | 1 |
| KBFC = Kneading Block (R) | 2 |
| LHKB = Hand Kneading Block | 6/3 |
| LHCE = (L) Convey Element | 50/15 |
| SFF = Low Pitch Single Flight Forward | 4 |
| LHNI = Left Hand Igel | 2.5 |
| SPEF = Special Elongational Flow Element | 2.5 |
| KBNC = Kneading Block Neutral (N) | 3.5 |
| Convey | |
| ZME, SME, TME, (R) | 3 |
| ZME, SME, TME, (L) | 4 |
| Elongational Flow Element | 8 |
| SFL = Low Pitch Single Flight, Left hand | 55/20 |
| Convey | |

The SFL, LHKB, and LHCE elements are considered to have a higher Restriction Factor (55, 6 and 50 respectively) when placed after mixing elements, and a less restrictive effect when placed after a conveying element (20, 3 and 15 respectively). Higher Restriction Factors are assigned when more than one left-handed element is located next to another left-handed element.

To describe the mixing value of a particular screw profile in absolute terms, it is expedient to describe the screw in terms of its meshes, i.e. the mixing potential of the screw independent of the rate of rotation, L/D, and the number of screws used. By dividing the number of meshes for a screw design with its L/D, a calculation for number of meshes per L/D for that screw design can be obtained.

In some embodiments, screws with up to 17 meshes per L/D, and L/D up to 100 with up to 170 mixing zones can be used. In some embodiments, as little as 3 mixing zones and 9 meshes per L/D can be used. Accordingly, processes can be performed using screws having a L/D of 15-100, with 3-170 mixing zones, and 3-17 meshes per (L/D).

Calculations for meshes of individual elements are given in the meshes table (Table 2). In the table, the element is described by type, the pitch factor, the length factor (given in L/D), the number of flights tips on the element, the restriction factor, and the effective element intensity. The restriction factor column shows the mixing potential for the element in meshes.

In the calculations, the pitch factor=screw diameter/pitch, for example, 30 mm/60 mm=0.5. This applies to SG, SK and S elements, but not to KBS, Igel, LH elements or kneading blocks. The length factor applies to all elements.

The number of tips for the element in the table of meshes is the number of flights×the number of elements or disks, which is 1×1=1 for a single flighted element or disk. For double flighted elements, the number of tips is 2×510 for a 5 disk double flighted kneading block, 2×5=10 for a double flighted 5 segmented Igel, and 2×6=12 for a six segmented SG element. For triple flighted kneading block with 5 disks, the number of tips is 3×515. By following these examples, this calculation can be used for conveying or mixing elements with >3 flights.

TABLE 2
(Table of Meshes)

| | | | | | | Effective |
|---|---|---|---|---|---|---|
| Screw | Element | Pitch | L/D | No. of | Restriction | Element |
| Element | Type | Factor | Factor | Flight Tips | Factor | Intensity |
| 30/30 | Conveying | 1.77 | 0.57 | 3 | 1 | 3 |
| 45/15 | Conveying | 1.18 | 0.28 | 3 | 1 | 1 |
| 45/15 LH | Mixing | 1.18 | 0.28 | 3 | 50/15 | 50/15 |
| 45/45 | Conveying | 1.18 | 0.85 | 3 | 1 | 3 |
| 60/20 | Conveying | 0.88 | 0.38 | 3 | 1 | 1 |
| 60/30 N-SF | Conveying | 0.88 | 0.57 | 1 | 4 | 2 |
| 60/30 SF-N | Conveying | 0.88 | 0.57 | 1 | 4 | 2 |
| 60/60 | Conveying | 0.88 | 1.13 | 3 | 1 | 3 |
| 80/80 | Conveying | 0.66 | 1.51 | 3 | 1 | 3 |
| 80/80 K | Conveying | 0.66 | 1.51 | 3 | 1 | 3 |
| 90/30 | Conveying | 0.59 | 0.57 | 3 | 1 | 1 |
| 90/30 SK-N | Conveying | 0.59 | 0.57 | 3 | 1 | 1 |
| KB30/5/20 | Mixing | 1 | 0.38 | 15 | 2 | 11 |
| KB30/5/20 LH | Mixing | 1 | 0.38 | 15 | 6/3 | 34/17 |
| KB30/5/45 | Mixing | 1 | 0.85 | 15 | 2 | 26 |
| KB30/5/60 | Mixing | 1 | 1.13 | 15 | 2 | 34 |
| KB60/3/30 | Mixing | 1 | 0.57 | 9 | 3.5 | 18 |
| KB60/3/60 | Mixing | 1 | 1.13 | 9 | 3.5 | 36 |
| ZME 15/30 | Mixing | 3.53 | 0.57 | 1 | 3 | 6 |

The summation of the effective element intensity of each element in the screw profile is the effective element intensity, as shown in the last column of the table of meshes above (Table 2). The total effective mixing intensity of the screw is 535. In some embodiments, a screw of the present disclosure is rotated at a rate of about 100 revolutions per minute (rpm) to about 500 rpm, such as about 200 rpm to about 400 rpm, such as about 275 rpm to about 375 rpm. In some embodiments, a screw of the present disclosure is operated at a total effective mixing intensity of the screw of about 450 to about 600, such as about 500 to about 550, such as about 530 to about 540.

Total mixing intensity is the summation of each element's mixing intensity in the screw design and the effective element intensity. The total mixing intensity can be determined using Equation 1.

$$Total Mixing Intensity = Element Pitch Factor \times Element L / D \times No . of Flight Tips of the Element \times Element Restriction Factor \qquad ( Eq . 1 )$$

Ultimately, the dynamic mixing intensity of the screw design can be a key assessment that indicates the degree of mixing power. For example, dynamic mixing intensity takes the mixing intensity and multiplies it by the process RPM in units of sec−1 and by a factor of 2 because there is a total of 2 rotating screws in the extrusion process. Dynamic mixing intensity can be determined using Equation 2.

$$Dynamic Mixing Intensity = No . Meshes \times Screw Speed \times No . Screws \qquad ( Eq . 2 )$$

For example, for a non-limiting example screw in which the twin screw extruder is mixing an EPDM rubber at 300 rpm, the dynamic mixing intensity=5,348 sec⁻¹. When operating at 350 rpm in the case of the butyl rubber, the overall mixing can be 6,239 sec⁻¹. In some embodiments, a screw of the present disclosure is operated at a dynamic mixing intensity of about 4,000 sec⁻¹ to about 6,500 sec⁻¹, such as about 5,000 sec⁻¹ to about 5,500 sec⁻¹, alternatively about 6,000 sec⁻¹ to about 6,500 sec⁻¹.

The length of the screw can be regarded as having approximately equal quintiles, and it is shown in Tables 3 and 4 that the Quintile 4 section of the screw profile is the dominant area of mixing intensity regardless of extruder rpm.

The first quintile of a screw is the quintile located proximate to the first end of the screw, e.g., proximate the feed throat of the extruder. In some embodiments, a first quintile of a screw of the present disclosure is operated at a dynamic mixing intensity of about 400 sec⁻¹ to about 900 sec⁻¹, such as about 500 sec⁻¹ to about 750 sec⁻¹, such as about 600 sec⁻¹ to about 750 sec⁻¹. In some embodiments, a second quintile of a screw of the present disclosure is operated at a dynamic mixing intensity of about 400 sec⁻¹ to about 900 sec⁻¹, such as about 500 sec⁻¹ to about 750 sec⁻¹, such as about 600 sec⁻¹ to about 710 sec⁻¹. In some embodiments, a third quintile of a screw of the present disclosure is operated at a dynamic mixing intensity of about 400 sec⁻¹ to about 900 sec⁻¹, such as about 450 sec⁻¹ to about 650 sec⁻¹, such as about 500 sec⁻¹ to about 600 sec⁻¹. In some embodiments, a fourth quintile of a screw of the present disclosure is operated at an dynamic mixing intensity of about 1,500 sec⁻¹ to about 3,000 sec⁻¹, such as about 2,000 sec⁻¹ to about 2,500 sec⁻¹, such as about 2,000 sec⁻¹ to about 2,250 sec⁻¹, alternatively about 2,250 sec⁻¹ to about 2,500 sec⁻¹. In some embodiments, a fifth quintile of a screw of the present disclosure is operated at an dynamic mixing intensity of about 1,000 sec⁻¹ to about 2,500 sec⁻¹, such as about 1,300 sec⁻¹ to about 2,000 sec⁻¹, such as about 1,300 sec⁻¹ to about 1,600 sec⁻¹, alternatively about 1,600 sec⁻¹ to about 1,800 sec⁻¹.

In some embodiments, a screw of the present disclosure is operated at a total effective mixing intensity of about 300 to about 700, such as about 400 to about 650, such as about 500 to about 600. In some embodiments, a first quintile of a screw of the present disclosure is operated at a total effective mixing intensity of about 40 to about 80, such as about 50 to about 70, such as about 60 to about 70. In some embodiments, a second quintile of a screw of the present disclosure is operated at a total effective mixing intensity of about 40 to about 80, such as about 50 to about 70, such as about 55 to about 65. In some embodiments, a third quintile of a screw of the present disclosure is operated at a total effective mixing intensity of about 30 to about 70, such as about 40 to about 60, such as about 45 to about 55. In some embodiments, a fourth quintile of a screw of the present disclosure is operated at a total effective mixing intensity of about 160 to about 240, such as about 180 to about 220, such as about 200 to about 220. In some embodiments, a fifth quintile of a screw of the present disclosure is operated at a total effective mixing intensity of about 110 to about 200, such as about 130 to about 170, such as about 145 to about 155.

TABLE 3
Sectional Screw Profile Analysis for a non-limiting example
screw with extruder operating at 300 rpm

| | Total effective Mixing | Dynamic Mixing |
|---|---|---|
| Screw Section | Intensity | Intensity |
| Quintile 1 | 64 | 643 |
| Quintile 2 | 60 | 603 |
| Quintile 3 | 50 | 501 |
| Quintile 4 | 212 | 2114 |
| Quintile 5 | 149 | 1487 |

TABLE 4
Sectional Screw Profile Analysis for a non-limiting example
screw with extruder operating at 350 rpm

| | Total Effective Mixing | Dynamic Mixing |
|---|---|---|
| Screw Section | Intensity | Intensity |
| Quintile 1 | 64 | 750 |
| Quintile 2 | 60 | 703 |
| Quintile 3 | 50 | 585 |
| Quintile 4 | 212 | 2466 |
| Quintile 5 | 149 | 1735 |

Mixing elements such as ZME, TME, SME, and elongational flow elements have meshes of 20, 15, 10, and 35, respectively. Calculations shown can be applied to elements of any diameter, L/D, number of flights or lobes, or number of disks. One skilled in the art will be able to use their own calculations for determining the number of intermeshes used in a particular extrusion. For example, if a screw has 396 meshes, and 6 screws are used at 360 RPM, the number of intermeshes/sec will be 396×6/sec×6=14,256.

In some embodiments, a screw profile may be used where the screw profile having 13 to 21 mixing zones of which 45 to 55% are conveying elements in 6-8 zones, 4-5% are flow splitters in 1-3 zones, 16 to 24% are restrictive conveying elements in 1-3 zones, 15 to 20% are pitched kneaders in 2-4 zones and 1 to 5% are back flow elements in 1-3 zones, wherein the screw has a mixing potential of 343 to 650 meshes can be used. The L/D ratio of screw profiles may be from L/D 36 to L/D 60.

In some embodiments, a screw of the present disclosure has a total of 300-700 meshes.

Residence times for the extrudate in an extruder of processes of the present disclosure can be determined empirically by adding color to the feed throat of the extruder after the start of extrusion from the die, and measuring the time occurred for a color change to appear at the extrusion die. In some embodiments, a residence time can be 15 to 180 seconds, depending on the materials being processed.

In some embodiments, a processing oil is added in one location or a plurality of locations along the extruder, in order to control the temperature and the consistency of the composition as it is being processed, as well as to control the properties of an extrudate end product.

In some embodiments, specific energy of the extruder is about 0.17 to 0.28 kw/kg.

In some embodiments, the extruder can be operated at an output capacity of about 10 kilograms per hour (kg/h) to about 6,000 kg/h, such as about 10 kg/h to about 300 kg/h, alternatively about 300 kg/h to about 1,500 kg/h, alternatively about 1,500 kg/h to about 3,000 kg/h, alternatively about 3,000 kg/h to about 6,000 kg/h.

### Additive Source

An additive source can be any suitable additive source, such as an additive source that is commercially available. For example, an additive source provides one or more additives, such as an antioxidant and/or carbon material, to the extrudate being extruded through extruder.

In some embodiments, the additive source is coupled with the extruder (e.g., via a port) at a mid portion (e.g., the initial ¼ to ¾ of the length, such as ½ of the length) of the extruder.

### Coupling Agent Source

A coupling agent source can be any suitable coupling agent source, such as a coupling agent source that is commercially available. For example, the coupling agent source provides one or more coupling agents, such as a silane, to the extrudate being extruded through extruder.

Coupling agent can be added to the extrudate at a particular location along the extruder to reduce or eliminate formation of H₂S, which can otherwise form if a polymer is not sufficiently cross-linked. In some embodiments, the coupling agent source is coupled with the extruder (e.g., via a port) at a mid portion (e.g., the initial ¼ to ¾ of the length, such as ½ of the length) of the extruder.

In some embodiments, the coupling agent source is coupled with extruder at a location corresponding to a flow zone that is downstream of the location on the extruder where the additive source is coupled.

### Rubber Feeder

A rubber feeder of the present disclosure may be any suitable rubber feeder, such as a rubber feed commercially available from the Bonnot Company of Akron, Ohio. The rubber feeder is coupled with the feed throat of the extruder to introduce a heated polymer melt to the extruder. The polymer melt can include softened feed, melted feed, or combination(s) thereof.

A rubber feeder may include a motor coupled with a first end of a gear box. The gear box is coupled at a second end with a first end of a hopper. The hopper includes a plurality of grinders having a plurality of teeth that are configured to grind a solid feed into small particles. Grinders can be operated (e.g., rotated) by the motor and gear box. The hopper is coupled at second end with a first end of an auger barrel. A plurality of heating jackets is disposed about auger barrel and each heating jacket corresponds to a heating zone to provide controlled heating of the small particles from the hopper.

The feed that is fed into the hopper can be any suitable size. For example, the feed can have an average size of about 3 inches or less, such as about 2 inches or less. The small particles formed from the hopper can have a size of about 0.5 inches or less, such as about 0.25 inches or less. The small particles are directed to the interior space of the auger barrel. A screw is rotably positioned within the auger barrel. During use, rotation of the screw draws the feed/particles/melt from the hopper and moves the feed/particles/melt through the barrel during the heat processing of the feed/particles/melt.

The front end of the screw is coupled with (e.g., connected to) the gear box. The gear box is configured to rotate the screw during use. In some embodiments, the screw has a width of about 1 inch to about 10 inches, such as about 2 inches to about 6 inches, such as about 3 inches to about 4 inches. The screw includes a plurality of flights. The spacing between flights of the plurality of flights can vary, e.g., the flight spacing is greater near the front end of the screw and then reduces continuously or at some point along the front portion of the screw.

The heat jackets are configured to heat the feed/particles/melt as they move inside the auger barrel by the rotation of the screw. The heat jackets can have any suitable size or configuration, or there can be any suitable number of heat jackets. The heat jackets can be heated by fluid (e.g., heated oil, steam, etc.) flowing and/or circulating through the heat jackets and/or can be electric heaters. Generally, the heat jackets are configured to heat the feedstock (e.g., polymer) at a temperature of about 200° F. to about 700° F., such as about 300° F. to about 600° F., such as about 350° F. to about 450° F. The heating of the feedstock in the beginning or front portion of the rubber feeder causes water in the feed, if any, to vaporize.

The rubber feeder is coupled with (e.g., connected to) the extruder at a feeder end to provide the polymer melt to the extruder and commence functionalizing the polymer, e.g., as described above. In some embodiments, the polymer melt is provided to the extruder at a rate of about 40 kg/hr to about 2,500 kg/hr, such as 400 kg/hr to about 2,500 kg/hr, such as 1,200 kg/hr to about 2,500 kg/hr, alternatively about 1,000 kg/hr to about 2,000 kg/hr.

In some embodiments, the rubber feeder is coupled with the extruder (used to functionalize the polymer) at a first portion (e.g., the initial ⅛ to ½ of the length, such as ¼ of the length) of the extruder. For example, the rubber feeder can be coupled with the extruder at a location corresponding to flow zones of the screw used in the extruder for functionalizing the polymer.

### Melt Pump

A melt pump of the present disclosure, such as melt pump 112, may be any suitable melt pump, such as a twin screw melt pump, such as a melt pump commercially available from Henschel GmbH of Germany. The melt pump is coupled at a first end with a second end of an extruder and is coupled at a second end with a first end of an extrusion die.

The melt pump can be a multi-screw extruder (e.g., twin screw extruder) having a horizontal screw arrangement where the feed is fed/removed in a top/bottom configuration. The melt pump can have a cylinder housing operated at a temperature using heating cartridges and water cooling. The melt pump can have one or more screws having a diameter of about 60 millimeters (mm) to about 200 mm, such as about 100 mm to about 140 mm. During use, the screw can be rotated at a speed of about 15 min⁻¹ to about 160 min⁻¹, such as about 53 min⁻¹ to about 150 min⁻¹, alternatively about 31 min⁻¹ to about 94 min⁻¹, alternatively about 23 min⁻¹ to about 69 min⁻¹, alternatively about 16 min⁻¹ to about 47 min⁻¹. The screw can be controlled using a motor operated at a power of about 4 kilowatts (kW) to about 140 kW, such as about 4 kW to about 12 kW, alternatively 11 kW to about 36 kW, alternatively 23 kW to about 70 kW, alternatively 45 kW to about 140 kW. The melt pump can be operated at an output torque of about 700 Newton meter (Nm) to about 28,300 Nm, such as about 3,600 Nm to about 9,800 Nm. The melt pump can be operated at an output capacity of about 10 kilograms per hour (kg/h) to about 6,000 kg/h, such as about 10 kg/h to about 300 kg/h, alternatively about 300 kg/h to about 1,500 kg/h, alternatively about 1,500 kg/h to about 3,000 kg/h, alternatively about 3,000 kg/h to about 6,000 kg/h. The melt pump can be operated at a pressure of about 100 bar to about 500 bar, such as 200 bar to about 350 bar.

The melt pump can be designed such that the twin screws rotate at rotation speeds of about 30 rpm to about 300 rpm, such as about 50 rpm to about 150 rpm, depending on the type of extrudate. The chosen rotation speed can be chosen so that the melt is conveyed with significantly reduced or no pulsation.

A gear can be disposed between the compressor and the advantageously electrical drive, by way of which the twin screws are synchronously drivable. A reciprocal, geometrically accurate interlock of the flights is possible because of the synchronization. One screw of the twin screws is thereby advantageously not moved along by a mechanical forced coupling as in geared pumps from known examples but rather directly driven, so that high friction with the known disadvantages of high energy consumption and an inevitably associated temperature increase is avoided. This also makes it possible to operate the twin screws so that each screw rotates in opposite directions. The synchronization from the gear is furthermore advantageous in that drive forces also can be introduced directly into both twin screws, in order to achieve a better force distribution.

By way of example, the flights of both twin screws can engage with each other in such a manner that the flight gap remaining at the narrowest location forms a gap seal. This gap seal prevents the reflux of extrudate and increases the force feed and also acts as overpressure compensation. The force feed generates a high pressure buildup and, simultaneously, the pressure compensation prevents damage to the extrudate, more specifically when the gap seal is adapted to the medium to be processed. The same advantages may also apply to the housing gap.

Another advantage is that the twin screws may be driven with relatively low output, which leads to a smaller drive motor and a lesser energy consumption.

Furthermore, the number of chambers, in which the extrudate is contained, are formed between the housing and the twin screws or their flights. The chambers can be quasi closed in accordance with the gap seal and/or housing gap so that the desired pressure may be built up but that in examples with a locally excessive pressure, compensation of the pressure occurs.

Moreover, the chamber extends along the pitch of a flight. The beginning and the end of the chamber are thereby located at the intersection of the two twin screws (e.g., in the plane defined by the axes of the two twin screws), which is advantageous in that the extrudate occupies a defined place and is not mixed with another medium. At the same time, this allows for an efficient pressure build up on the perforated disc.

A housing gap can be formed between the flight and the casing, and a gap is formed between the flight and its adjacent counter-rotating twin screws, which both form a gap seal, so that the medium is substantially held in the respective chamber without a significant reflux of the medium occurring through the gaps (e.g., gap seal) into an adjacent rearward chamber. This is advantageous in that a seal is achieved between the chambers, which allow for a high pressure in each chamber and a pressure of about 400 to about 600 bar on the perforated disc and a temperature of about 100° C. to about 300° C.

The housing gap and/or the gap can have a width of about 0.05 mm to about 2 mm. The width of the gap and, thus, the size of the gap seal ultimately depend on the medium to be processed and its additives.

Twin screws are configured in such a manner that the ratio of the outer diameter relative to the core diameter is approximately 2. Depending on the type of melt (extrudate) a ratio between Da and Di having a range of about 1.6 to about 2.4 may also be chosen, thereby resulting in a large delivery volume achieved with a relatively thin and, thus, cost-effective melt pump. Having a length/diameter ratio of the counter-rotating twin screws of about 2 to about 5, such as about 3.5, the vessel may achieve a pressure of about 250 bar to about 600 bar on the perforated disc and a temperature of about 100° C. to about 350° C. This is advantageous in that the melt pump can be manufactured at low cost and utilized in a space-saving manner.

Relatively quick pressure buildup is achieved due to the cooperation of the two accurately intermeshing twin screws with the correspondingly configured flights. High pressures may be achieved, effectively breaking cross-linking (if present) in the melt thereby reducing or eliminating gel formation in the melt vessel (and in the extrusion die and subsequent pelletizer downstream of the extrusion die), and the retention period in the vessel may be relatively small, and therefore, reducing potential thermal and mechanical damage to the extrudate.

Upon exiting the melt pump (die thereof), the composition can be pelletized. For example, the composition may be fed to a pelletizer where the composition is then discharged through a pelletization die as formed pellets. The pellets may be used to form tire products of the present disclosure. Pelletization of the composition may be by an underwater, hot face, strand, water ring, or other similar pelletization. Preferably an underwater pelletizer is used, but other equivalent pelletizing units known to those skilled in the art may also be used. Small pellets may be formed in an underwater pelletization process vs. dropping the composition on a mill and then going into a water tray for a batch process. Small pellets provides tire products having improved compositional uniformity.

### Functionalized Polymers and Compositions Thereof

Compositions of the present disclosure include one or more functionalized polymer (e.g., rubber), a plasticizer, a carbon material, a coupling agent (e.g., unreacted coupling agent from an extrusion process), and an antioxidant. In some embodiments, a composition further includes a diene elastomer. A diene elastomer can be introduced as part of the polymer melt from a rubber feeder to the extruder of a process of the present disclosure. Similarly, a plasticizer can be introduced as part of the polymer melt from a rubber feeder to the extruder and/or at a port along an extruder of a process of the present disclosure. Alternatively, a diene elastomer and/or a plasticizer can be compounded with a composition post-extrusion by any suitable method.

A functionalized polymer can be a functionalized butyl rubber, a functionalized ethylene-propylene-diene terpolymer, a functionalized poly(isobutylene-co-para-methylstyrene-co-isoprene) terpolymer, or combination(s) thereof.

Because of advantageous processes and extrusion systems of the present disclosure, compositions of the present disclosure can be substantially free of (e.g., completely free of) inorganic fillers. In some embodiments, a composition has an inorganic filler content of about 0 parts per hundred rubber (phr) to about 100 phr, such as 1 phr to about 10 phr, alternatively 0 phr to about 5 phr, such as 0 phr.

In some embodiments, a composition includes, per 100 parts by weight of rubber (phr) (e.g., per 100 parts by weight of the functionalized polymer), about 0 or 0.01 to about 15 phr plasticizer, such as about 0.01 to about 10 phr plasticizer.

In some embodiments, a composition includes, per 100 parts by weight of rubber (phr) (e.g., per 100 parts by weight of the functionalized polymer), about 0.1 to about 1 phr carbon material. In another embodiment, a composition includes, per 100 parts by weight of rubber (phr), about 0.1 to about 0.5 phr carbon material. In a further embodiment, a composition includes, per 100 parts by weight of rubber (phr), about 0.1 to about 0.3 phr carbon material.

In some embodiments, a composition includes, per 100 parts by weight of rubber (phr) (e.g., per 100 parts by weight of the functionalized polymer), about 0.1 to about 10 phr coupling agent. In another embodiment, a composition includes, per 100 parts by weight of rubber (phr), about 1 to about 5 phr coupling agent. In a further embodiment, a composition includes, per 100 parts by weight of rubber (phr), about 2 to about 3 phr coupling agent.

In some embodiments, a composition includes, per 100 parts by weight of rubber (phr) (e.g., per 100 parts by weight of the functionalized polymer), about 0 or 0.01 to about 2 phr antioxidant.

### Coupling Agents

As used herein, the term “coupling agent” is meant to refer to an agent capable of facilitating stable chemical and/or physical interaction between two otherwise non-interacting species, e.g., between a diene elastomer and polymer of a composition of the present disclosure.

The coupling agent can also include combinations of one or more coupling agents. For example, the coupling agent may be a sulfur-based coupling agent, an organic peroxide-based coupling agent, an inorganic coupling agent, a polyamine coupling agent, a resin coupling agent, a sulfur compound-based coupling agent, oxime-nitrosamine-based coupling agent, and combination(s) thereof. Among these, for a rubber composition for tires, a non-limiting example coupling agent is a sulfur-based coupling agent.

In an aspect, the coupling agent is a silane coupling agent. Non-limiting examples of silane coupling agents include organosilanes or polyorganosiloxanes. Particular silanes used in the present terpolymer and tire tread compositions include silanes of the following structures:

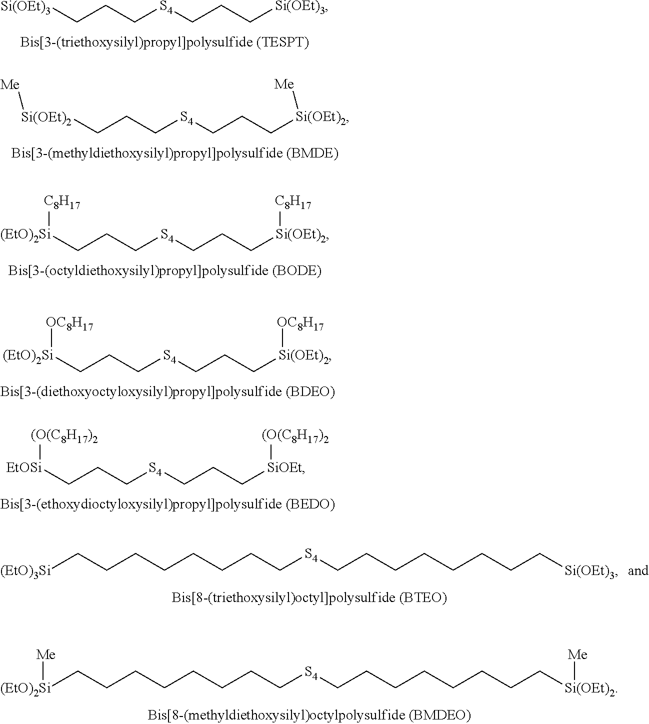

Other examples of suitable silane coupling agents include silane polysulfides, referred to as “symmetrical” or“unsymmetrical” depending on their specific structure.

Silane polysulphides can be described by the formula (V):

Z-A-Sₓ-A-Z (V)

in which x is an integer from 2 to 8 (such as from 2 to 5); the A symbols, which are identical or different, represent a divalent hydrocarbon radical (such as a C₁-C₁₈ alkylene group or a C₆-C₁₂ arylene group, more particularly a C₁-C₁₀, in particular C₁-C₄, alkylene, especially propylene); the Z symbols, which are identical or different, correspond to one of the three formulae (VIa, VIb, and VIc):

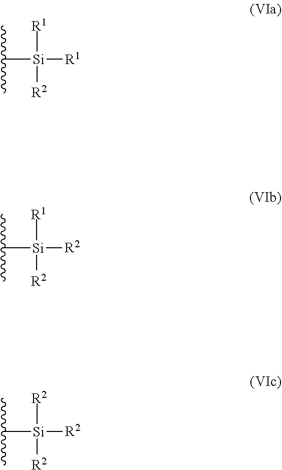

in which the R¹ radicals, which are substituted or unsubstituted and identical to or different from one another, represent a C₁-C₁₈ alkyl, C₅-C₁₅ cycloalkyl or C₆-C₁₈ aryl group (such as C₁-C₆ alkyl, cyclohexyl or phenyl groups, in particular C₁-C₄ alkyl groups, more particularly methyl and/or ethyl); the R² radicals, which are substituted or unsubstituted and identical to or different from one another, represent a C₁-C₁₈ alkoxyl or C₅-C₁₅ cycloalkoxyl group (such as a group selected from C₁-C₈ alkoxyls and C₅-C₈ cycloalkoxyls, such as a group selected from C₁-C₄ alkoxyls, in particular methoxyl and ethoxyl).

Non-limiting examples of silane polysulphides include bis((C₁-C₄)alkoxy(C₁-C₄)alkylsilyl(C₁-C₄)alkyl)polysulphides (in particular disulphides, trisulphides or tetrasulphides), such as, for example, bis(3-trimethoxysilylpropyl) or bis(3-triethoxysilylpropyl)polysulphides. Further examples include bis(3-triethoxysilylpropyl)tetrasulphide, abbreviated to TESPT, of formula [(C₂H₅O)₃Si(CH₂)₃S₂]₂, or bis(triethoxysilylpropyl)disulphide, abbreviated to TESPD, of formula [(C₂H₅O)₃Si(CH₂)₃S]₂. Other examples include bis(mono(C₁-C₄)alkoxyldi(C₁-C₄)alkylsilylpropyl)polysulphides (in particular disulphides, trisulphides or tetrasulphides), for example bis(monoethoxydimethylsilylpropyl)tetrasulphide.

The silane coupling agent can also be bifunctional POSs (polyorganosiloxanes), hydroxysilane polysulphides, silanes, or POSs bearing azodicarbonyl functional groups. The coupling agent can also include other silane sulphides, for example, silanes having at least one thiol (—SH) functional group (referred to as mercaptosilanes) and/or at least one masked thiol functional group.

The silane coupling agent can also include combinations of one or more coupling agents such as those described herein, or otherwise known in the art. A coupling agent can comprise alkoxysilane or polysulphurized alkoxysilane. A polysulphurized alkoxysilane is bis(triethoxysilylpropyl) tetrasulphide, which is commercially available by Degussa under the trade name X50S™.

### Polymers

Polymers of the present disclosure can be any suitable polymer for functionalizing with one or more coupling agents. Polymers of the present disclosure can be any suitable polymer for use in an extruder system of the present disclosure. In some embodiments, a polymer is a butyl rubber (e.g., butyl copolymer rubber), an ethylene-propylene-diene terpolymer, poly(isobutylene-co-para-methylstyrene-co-isoprene) terpolymer, or combination(s) thereof. These polymers, which may be functionalized using an extrusion system of the present disclosure, are useful in tire tread compositions. For example, the functionalized polymers can increase hysteresis in the wet traction region (0° C.) and lowers hysteresis in the rolling resistance region (60° C.). Once functionalized, the polymer is present in a composition of the present disclosure as a functionalized polymer which can be a functionalized butyl rubber, a functionalized ethylene-propylene-diene terpolymer, a functionalized poly(isobutylene-co-para-methylstyrene-co-isoprene) terpolymer, or combination(s) thereof.

### Butyl Rubber

The butyl copolymer rubbers are prepared by polymerizing (i) C₄-C₇ isoolefins with (ii) C₄-C₁₄ conjugated dienes. The butyl copolymer rubbers contain from 85 to 99.5 mol % C₄-C₇ isoolefins and from 0.5 to 15 mol % C₄-C₁₄ conjugated dienes. For example, the 30 butyl copolymer rubber is Butyl 365 (ExxonMobil Chemical). In an embodiment, the butyl copolymer rubbers may be halogenated. For example, the halogenated butyl copolymer rubber is Exxon™ bromobutyl rubber or Exxon™ chlorobutyl rubber.

The term “butyl rubber” or “butyl rubber copolymer” as used in the specification means copolymers of C₄ to C₇ isoolefins and C₄ to C₁₄ conjugated dienes which comprise about 0.5 to about 15 mol % conjugated diene and about 85 to 99.5 mol % isoolefin. Illustrative examples of the isoolefins which may be used in the preparation of butyl rubber are isobutylene, 2-methyl-1-propene, 3-methyl-1-butene, 4-methyl-1-pentene and beta-pinene. Illustrative examples of conjugated dienes which may be used in the preparation of butyl rubber are isoprene, butadiene, 2,3-dimethyl butadiene, piperylene, 2,5-dimethylhexa-2,4-diene, cyclopentadiene, cyclohexadiene and methylcyclopentadiene. The preparation of butyl rubber is described in U.S. Pat. No. 2,356,128 and is further described in an article by R. M. Thomas, et al. in Ind. & Eng. Chem., vol. 32, pp. 1283 et seq., October 1940. Butyl rubber generally has a viscosity average molecular weight between about 100,000 to about 1,500,000, such as about 250,000 to about 800,000 and a Wijs Iodine No. (INOPO) of about 0.5 to 50, such as 1 to 20 (for a description of the INOPO test, see Industrial and Engineering Chemistry, Vol. 17, p. 367, 1945).

The term “butyl rubber” also encompasses functionalized butyl rubber compounds described herein. The butyl rubber may have a C₄ to C₇ isoolefin(s) amount of from about 85 to about 99.5 mol %, or from about 90 to about 99.5 mol % or from about 95 to about 99.5 mol %, based on the weight of the butyl rubber.

The butyl rubber may have a C₄ to C₁₄ conjugated diene(s) amount of from about 0.5 to about 15 mol %, or from about 0.5 to about 10 mol % or from about 0.5 to about 5 mol %, based on the weight of the butyl rubber.

An example of a butyl rubber is BUTYL 365 or 365S (butyl, isobutylene-isoprene rubber (IIR), available from ExxonMobil Chemical Company). BUTYL 365 or 365S is a copolymer of isobutylene and isoprene with about 2.3 mole % unsaturation. Other examples are Exxon BUTYL 065 or 065S (copolymer of isobutylene and isoprene with about 1.05 mole % unsaturation), Exxon BUTYL 068 (copolymer of isobutylene and isoprene with about 1.15 mole % unsaturation) and Exxon BUTYL 268 or 268S (copolymer of isobutylene and isoprene with about 1.7 mole % unsaturation).

In an embodiment, the butyl copolymer rubber may be halogenated. For example, the halogenated butyl copolymer rubber is brominated poly(isobutylene-co-isoprene). Examples of halogenated butyl copolymer rubbers are Exxon™ bromobutyl rubber or Exxon™ chlorobutyl rubber. An example of a halogenated butyl copolymer is Bromobutyl 2222 (ExxonMobil Chemical). Another example of a halogenated butyl rubber is Exxon SBB 6222 (Exxon Mobil), a brominated star branched butyl rubber.

In at least one embodiment, the butyl rubber is functionalized with sulfur.

In another embodiment, the butyl rubber is functionalized with sulfur and an activator. In a further embodiment, the activator is zinc oxide or stearic acid. In a further embodiment, the activator is a combination of zinc oxide and stearic acid.

In another embodiment, the butyl rubber is functionalized with sulfur and a silane coupling agent. In a further embodiment, the silane coupling agent is bis(3-triethoxysilylpropyl)tetrasulphide (TESPT) (available as Si69® from Evonik Industries) and bis[3-(diethoxy octyloxysilyl)propyl]tetrasulfide (from Shin-Etsu).

In another embodiment, the butyl rubber is functionalized with sulfur, an activator and a silane coupling agent.

In another embodiment, the butyl rubber is functionalized with sulfur and a vulcanizing accelerator. In a further embodiment, the vulcanizing accelerator is n-tertiarybutyl-2-benzothiazyl sulfenamide (TBBS).

The compositions may include the butyl rubber in an amount of from 5 phr to 30 phr, or from 5 phr to 25 phr.

### Ethylene-Propylene-Diene Terpolymer

The “ethylene-propylene-diene terpolymer” as used herein may be any polymer comprising propylene and other comonomers. The term “polymer” refers to any carbon containing compound having repeat units from one or more different monomers. The term “terpolymer” as used herein refers to a polymer synthesized from three different monomers.

The ethylene-propylene-diene terpolymers are prepared by polymerizing (i) propylene with (ii) at least one of ethylene and C₄-C₂₀ α-olefins and (iii) one or more dienes such as ethylidene norbornene. In an embodiment, the ethylene-propylene-diene terpolymer may be halogenated. In another embodiment, the ethylene-propylene-diene terpolymer is amorphous ethylene-propylene-diene terpolymer.

Terpolymers, in some embodiments, may be produced (1) by mixing all three monomers at the same time or (2) by sequential introduction of the different comonomers. The mixing of comonomers may be done in one, two, or possible three different reactors in series and/or in parallel. As an example, the ethylene-propylene-diene terpolymer comprises (i) propylene derived units, (ii) α-olefin-derived units and (iii) diene-derived units. The ethylene-propylene diene terpolymer may be prepared by polymerizing (i) propylene with (ii) at least one of ethylene and C₄-C₂₀ α-olefins and (iii) one or more dienes.

The comonomers may be linear or branched. Example linear comonomers include ethylene or C₄ to C₈ α-olefins, such as ethylene, 1-butene, 1-hexene, and 1-octene, such as ethylene or 1-butene. Example branched comonomers include 4-methyl-1-pentene, 3-methyl-1-pentene, and 3,5,5-trimethyl-1-hexene. In one or more embodiments, the comonomers may include styrene.

The dienes may be conjugated or non-conjugated. For example, the dienes are nonconjugated.

Illustrative dienes may include, but are not limited to, 5-ethylidene-2-norbornene (ENB); 1,4-hexadiene; 5-methylene-2-norbornene (MNB); 1,6-octadiene; 5-methyl-1,4-hexadiene; 3,7-dimethyl-1,6-octadiene; 1,3-cyclopentadiene; 1,4-cyclohexadiene; vinyl norbornene (VNB); dicyclopendadiene (DCPD); and combinations thereof. For example, the diene is ENB or VNB. For example, the ethylene-propylene-diene terpolymer comprises an ENB content of from 0.5 wt % to 8 wt % based on the weight of the terpolymer, or from 2 wt % to 6 wt %, or from 3 wt % to 5 wt %. For example, the ethylene-propylene-diene terpolymer comprises an ENB content of from 0.5 wt % to 3 wt %.

The ethylene-propylene-diene terpolymer may have a propylene amount of from 65 wt % to 95 wt %, or from 70 wt % to 95 wt %, or from 75 wt % to 95 wt %, or from 80 wt % to 95 wt %, or from 83 wt % to 95 wt %, or from 84 wt % to 95 wt %, or from 84 wt % to 94 wt %, or from 72 wt % to 95 wt %, or from 80 wt % to 93 wt %, or from 85 wt % to 89 wt %, based on the weight of the polymer. The balance of the ethylene-propylene-diene terpolymer comprises at least one of ethylene and C₄-C₂₀α-olefin and one or more dienes. The α-olefin may be ethylene, butene, hexane, or octene. When two or more α-olefins are present in the polymer, ethylene and at least one of butene, hexane, or octene may be used.

In some embodiments, the ethylene-propylene-diene terpolymer comprises from 2 to 30 wt % of C₂ and/or C₄-C₂₀ α-olefins based the weight of the ethylene-propylene-diene terpolymer. When two or more of ethylene and C₄-C₂₀ α-olefins are present the combined amounts of these olefins in the polymer can be at least 2 wt % and falling within the ranges described herein. Other ranges of the amount of ethylene and/or one or more α-olefins may include from 2 wt % to 15 wt %, or from 5 wt % to 15 wt %, or from 8 wt % to 15 wt %, or from 8 to 12 wt %, based on the weight of the ethylene-propylene-diene terpolymer.

In some embodiments, the ethylene-propylene-diene terpolymer comprises an ethylene content of from 5 wt % to 25 wt % based on the weight of the terpolymer, or from 8 wt % to 12 wt %.

In some embodiments, the ethylene-propylene-diene terpolymer comprises a diene content of from 1 wt % to 16 wt % based on the weight of the terpolymer, or from 1 wt % to 12 wt %, or 2 wt % to 6 wt %, or from 2 wt % to 6 wt %.

In at least one embodiment, the ethylene-propylene-diene terpolymer is halogenated. The ethylene-propylene-diene terpolymer may be halogenated by methods known in the art or by methods described in U.S. Pat. No. 4,051,083.

In at least one embodiment, the synthesis of the ethylene-propylene-diene terpolymer utilizes a bis((4-triethylsilyl)phenyl)methylene(cyclopentadienyl)(2,7-di-tert-butyl-fluoren-9-yl) hafnium dimethyl catalyst precursor. However, other metallocene precursors with good diene incorporation and MW capabilities could also be used. The synthesis of the ethylenepropylene-diene terpolymer also utilizes a dimethylanilinium tetrakis(pentafluorophenyl)borate activator but dimethylaniliniumtetrakis(heptafluoronaphthyl)borate and other non-coordinating anion type activators or MAO could also be used.

In a reactor, a copolymer material is produced in the presence of ethylene, propylene, ethylidene norbornene, and a catalyst comprising the reaction product of N,Ndimethylanilinium tetrakis(pentafluorophenyl)borate and [cyclopentadienyl(2,7-di-tbutylfluorenyl) di-p-triethylsilanephenylmethane] hafnium dimethyl. The copolymer solution emerging from the reactor is quenched and then devolatilized using conventionally known devolatilization methods, such as flashing or liquid phase separation, first by removing the bulk of the isohexane to provide a concentrated solution, and then by stripping the remainder of the solvent in anhydrous conditions using a devolatilizer so as to end up with a molten polymer composition containing less than 0.5 wt % of solvent and other volatiles. The molten polymer composition was advanced by a screw to a pelletizer from which the ethylene-propylene-diene terpolymer composition pellets are submerged in water and cooled until solid.

The ethylene-propylene-diene terpolymer may have a melt flow rate (MFR, 2.16 kg weight at 230° C.), equal to or greater than 0.1 g/10 min as measured according to the ASTM D-1238-13. In some embodiments, the MFR (2.16 kg at 230° C.) is from 0.5 g/10 min to 200 g/10 min, or from 0.5 g/10 min to 100 g/10 min, or from 0.5 g/10 min to 30 g/10 min, or from 0.5 g/10 min to 10 g/10 min, or from 0.5 g/10 min to 5 g/10 min, or from 0.5 g/10 min to 2 g/10 min, or from 0.1 g/10 min to 15 g/10 min.

The ethylene-propylene-diene terpolymer may have a heat of fusion (Hf) determined by the DSC procedure described herein, which is greater than or equal to 0 Joules per gram (J/g), and is equal to or less than 80 J/g, or equal to or less than 75 J/g, or equal to or less than 70 J/g, or equal to or less than 60 J/g, or equal to or less than 50 J/g, or equal to or less than 35 J/g. In some embodiments, the Hf is 0 J/g.

The crystallinity of the ethylene-propylene-diene terpolymer may be expressed in terms of percentage of crystallinity (e.g., % crystallinity), as determined according to the DSC procedure described herein. The ethylene-propylene-diene terpolymer may have a % crystallinity of from 0% to 40%. In some embodiments, the % crystallinity is 0%. The ethylene-propylenediene terpolymer may have a single broad melting transition. However, the ethylene-propylene-diene terpolymer may show secondary melting peaks adjacent to the principal peak, but for purposes herein, such secondary melting peaks are considered together as a single melting point, with the highest of these peaks (relative to baseline as described herein) being considered as the melting point of the ethylene-propylene-diene terpolymer.

The Differential Scanning Calorimetry (DSC) procedure may be used to determine heat of fusion and melting temperature of the ethylene-propylene-diene terpolymer. The method is as follows: approximately 6 mg of material placed in microliter aluminum sample pan. The sample is placed in a Differential Scanning Calorimeter (Perkin Elmer Pyris 1 Thermal Analysis System) and is cooled to −80° C. The sample is heated at 10° C./min to attain a final temperature of 120° C. The sample is cycled twice. The thermal output, recorded as the area under the melting peak of the sample, is a measure of the heat of fusion and may be expressed in Joules per gram of polymer and is automatically calculated by the Perkin Elmer System. The melting point is recorded as the temperature of the greatest heat absorption within the range of melting of the sample relative to a baseline measurement for the increasing heat capacity of the polymer as a function of temperature.

The ethylene-propylene-diene terpolymer may be a blend of discrete random ethylene-propylene-diene terpolymers as long as the polymer blend has the properties of the ethylene-propylene-diene terpolymer as described herein. The number of ethylene-propylenediene terpolymers may be three or less, or two or less. In one or more embodiments, the ethylene-propylene-diene terpolymer may include a blend of two ethylene-propylene-diene terpolymers differing in the olefin content, the diene content, or the both.

In at least one embodiment, the ethylene-propylene-diene terpolymer is functionalized with sulfur.

In another embodiment, the ethylene-propylene-diene terpolymer is functionalized with sulfur and an activator. In a further embodiment, the activator is zinc oxide or stearic acid. In a further embodiment, the activator is a combination of zinc oxide and stearic acid.

In another embodiment, the ethylene-propylene-diene terpolymer is functionalized with sulfur and a silane coupling agent. In a further embodiment, the silane coupling agent is bis(3-triethoxysilylpropyl)tetrasulphide (TESPT) (available as Si69® from Evonik Industries) and bis[3-(diethoxy octyloxysilyl)propyl]tetrasulfide (from Shin-Etsu).

In another embodiment, the ethylene-propylene-diene terpolymer 5 is functionalized with sulfur, an activator and a silane coupling agent.

In another embodiment, the ethylene-propylene-diene terpolymer is functionalized with sulfur and a vulcanizing accelerator. In a further embodiment, the vulcanizing accelerator is n-tertiary-butyl-2-benzothiazyl sulfenamide (TBBS).

The compositions may include the ethylene-propylene-diene terpolymer in an amount of from 5 phr to 30 phr, or from 5 phr to 25 phr, or from 10 phr to 20 phr.

### Poly(Isobutylene-Co-Para-Methylstyrene-Co-Isoprene) Terpolymers

The term “poly(isobutylene-co-para-methylstyrene-co-isoprene) terpolymer” as used in the specification means a terpolymer comprising isobutylene, para-methylstyrene and isoprene polymers.

The poly(isobutylene-co-para-methylstyrene-co-isoprene) terpolymers (IB-IPPMS) are prepared as described in U.S. Pat. No. 6,960,632 or as described herein. Poly(isobutylene-co-para-methylstyrene-co-isoprene) terpolymer is prepared by adding an initiator/co-initiator solution to a mixed para-methyl styrene, isoprene, and isobutylene monomer solution using standard slurry cationic polymerization techniques. In an embodiment, the poly(isobutylene-co-para-methylstyrene-co-isoprene) terpolymer may be halogenated.

In at least one embodiment, the poly(isobutylene-co-para-methylstyrene-co-isoprene) terpolymer contains from 4-8 mol % p-methylstyrene, 0.2-2 mol % isoprene and 90-95 mol % isobutylene based on the terpolymer.

In at least one embodiment, the poly(isobutylene-co-para-methylstyrene-co-isoprene) terpolymer is functionalized with sulfur.

In another embodiment, the poly(isobutylene-co-para-methylstyrene-co-isoprene) terpolymer is functionalized with sulfur and an activator. In a further embodiment, the activator is zinc oxide or stearic acid. In a further embodiment, the activator is a combination of zinc oxide and stearic acid.

In another embodiment, the poly(isobutylene-co-para-methylstyrene-co-isoprene) terpolymer is functionalized with sulfur and a silane coupling agent. In a further embodiment, the silane coupling agent is bis(3-triethoxysilylpropyl)tetrasulphide (TESPT) (available as Si69® from Evonik Industries) and bis[3-(diethoxy octyloxysilyl)propyl]tetrasulfide (from Shin-Etsu).

In another embodiment, the poly(isobutylene-co-para-methylstyrene-co-isoprene) terpolymer is functionalized with sulfur, an activator and a silane coupling agent.

In another embodiment, the poly(isobutylene-co-para-methylstyrene-co-isoprene) terpolymer is functionalized with sulfur and a vulcanizing accelerator. In a further embodiment, the vulcanizing accelerator is n-tertiary-butyl-2-benzothiazyl sulfenamide (TBBS).

The compositions may include the poly(isobutylene-co-paramethylstyrene-co-isoprene) terpolymer in an amount of from 5 phr to 30 phr, or from 5 phr to 25 phr, or from 10 phr to 20 phr.

### Carbon Material

The carbon may be any size and range, for example in the tire industry, from 0.0001 μm to 100 μm.

In at least one embodiment, the composition comprises, per 100 parts by weight of rubber (phr), about 50 to 80 phr filler. In another embodiment, the composition comprises, per 100 parts by weight of rubber (phr), about 65 to 75 phr carbon.

All carbon blacks, in particular blacks of the HAF, ISAF or SAF type, conventionally used in tires (“tire-grade” blacks) are suitable as carbon blacks. Mention will more particularly be made, among the latter, of the reinforcing carbon blacks of the 100, 200 or 300 series (ASTM grades), such as, for example, the N115, N134, N234, N326, N330, N339, N347 or N375 blacks, or also, depending on the applications targeted, the blacks of higher series (for example, N660, N683 or N772). The carbon blacks might, for example, be already incorporated in the isoprene elastomer in the form of a masterbatch (see, for example, International Applications WO 97/36724 or WO 99/16600). In some embodiments, the carbon black is Vulcan®3 N330 from Cabot Corp.

### Plasticizer

As used herein, the term “plasticizer” (also referred to as a processing oil), refers to a petroleum derived processing oil and synthetic plasticizer. Such oils are primarily used to improve the processability of the composition. Suitable plasticizers include, but are not limited to, aliphatic acid esters or hydrocarbon plasticizer oils such as paraffinic oils, aromatic oils, naphthenic petroleum oils, and polybutene oils. A plasticizer may be naphthenic oil, which is commercially available by Nynas under the trade name Nytex™ 4700.

MES and TDAE oils are described in KGK (Kautschuk Gummi Kunstoffe), 52nd year, No. 12/99, pp. 799-805, entitled “Safe Process Oils for Tires with Low Environmental Impact”. Examples of MES oils (whether “extracted” or “hydrotreated”) and TDAE oils are sold under the names Flexon™ 683 by ExxonMobil, Vivatec™ 200 or Vivatec™ 500 by H&R European, Plaxolene™ MS by Total, or Catenex™ SNR by Shell.

“Triester” and “fatty acid” refers to a mixture of triesters or a mixture of fatty acids, respectively. A fatty acid is constituted majoritarily (greater than 50%, or more specifically, greater than 80% by weight) of an unsaturated Ci8 fatty acid. For example, fatty acids include oleic acid, linoleic acid, linolenic acid and mixtures thereof. Whether synthetic or natural in origin, fatty acids constitute more that 50% by weight and more than 80% by weight of oleic acid.

Further, glycerol trioleate, derived from oleic acid and glycerol, can be used. Examples of glycerol trioleates include vegetable oils sunflower oil or rapeseed oil having a high content of oleic acid (more than 50%, and more than 80% by weight).

The glycerol triester can be used in an amount of 5 to 80 phr, such as 10 to 50 phr, such as 15 to 30 phr, in particular when the tread of the present disclosure is intended for a passenger-type vehicle. In the light of the present description, the person skilled in the art will be able to adjust this amount of ester as a function of the specific conditions of embodiment of the present disclosure, in particular the amount of inorganic filler used.

Resins formed of C₅ fraction/vinylaromatic copolymer, in particular of C₅ fraction/styrene or C₅ fraction/C₉ fraction copolymer can be used as tackifiers for adhesives and paints, but are also useful as processing aids in tire tread compositions.

A C₅ fraction/vinylaromatic copolymer can be a copolymer of a vinylaromatic monomer and of a C₅ fraction. Styrene, alpha-methylstyrene, ortho-, meta- or para-methylstyrene, vinyltoluene, para-(tert-butyl)styrene, methoxystyrenes, chlorostyrenes, vinylmesitylene, divinylbenzene, vinylnaphthalene and any vinylaromatic monomer resulting from a C₉ fraction (or more generally from a C₅ to C₁₀ fraction), for example, are suitable as vinylaromatic monomers. The vinylaromatic compound is styrene or a vinylaromatic monomer resulting from a C₉ fraction (or more generally from a C₅ to C₁₀ fraction).

The term C₅ fraction (or, for example, C₉ fraction respectively) means any fraction resulting from a process resulting from petrochemistry or from the refining of petroleum, any distillation fraction predominantly comprising compounds having 5 (or respectively 9, in the case of a C₉ fraction) carbon atoms. By way of example C₅ fractions can comprise the following compounds, the relative proportions of which can vary according to the process by which they are obtained: 1, 3-butadiene, 1-butene, 2-butenes, 1,2-butadiene, 3-methyl-1-butene, 1,4-pentadiene, 1-pentene, 2-methyl-1-butene, 2-pentenes, isoprene, cyclopentadiene, which can be present in the form of its dicyclopentadiene dimer, piperylenes, cyclopentene, 1-methylcyclopentene, 1-hexene, methylcyclopentadiene or cyclohexene. These fractions can be obtained by chemical processes known in the petroleum industry and petrochemistry. Processes for the steam cracking of naphtha or processes for the fluid catalytic cracking of gasolines can be combined with chemical treatments to convert these fractions including, but not limited to, hydrogenation and dehydrogenation.

The plasticizing hydrocarbon resins can be homopolymers or copolymers of cyclopentadiene (CPD) or dicyclopentadiene (DCPD), homopolymers or copolymers of terpene, homopolymers or copolymers of terpene, homopolymers or copolymers of C cut and mixtures thereof. Such copolymer plasticizing hydrocarbon resins include, for example, resins made up of copolymers of (D)CPD/vinyl-aromatic, of (D)CPD/terpene, of (D)CPD/C cut, of terpene/vinyl-aromatic, of C₅ cut/vinyl-aromatic and of combinations thereof.

Terpene monomers useful for the terpene homopolymer and copolymer resins include alpha-pinene, beta-pinene and limonene, and polymers of the limonene monomers that include three isomers: the L-limonene (laevorotatory enantiomer); the D-limonene (dextrorotatory enantiomer); and dipentene, a racemic mixture of the dextrorotatory and laevorotatory enantiomers.

Examples of vinyl aromatic monomers include styrene, alpha-methylstyrene, ortho-, meta-, para-methylstyrene, vinyl-toluene, para-tertiobutylstyrene, methoxy styrenes, chloro-styrenes, vinyl-mesitylene, divinylbenzene, vinylnaphthalene, any vinyl-aromatic monomer coming from the C₉ cut (or, more generally, from a C₅ to C₁₀ cut), including a vinyl-aromatic copolymer include the vinyl-aromatic in the minority monomer, expressed in molar fraction, in the copolymer.

Plasticizing hydrocarbon resins include (D)CPD homopolymer resins, the (D)CPD/styrene copolymer resins, the polylimonene resins, the (D)CPD/styrene copolymer resins, the polylimonene resins, the limonene/styrene copolymer resins, the limonene/D(CPD) copolymer resins, C₅ cut/styrene copolymer resins, C₅ cut/C9 cut copolymer resins, and mixtures thereof.

### Antioxidant

As used herein, the term “antioxidant” refers to a chemical that combats oxidative degradation. Suitable antioxidants include diphenyl-p-phenylenediamine and those disclosed in The Vanderbilt Rubber Handbook (1978), Pages 344 to 346. A useful antioxidant is para-phenylenediamines, which is commercially available by Eastman under the trade name Santoflex™ 6PPD (N-(1,3-Dimethylbutyl)-N′-phenyl-1,4-phenylenediamine).

### Diene Elastomer

Compositions of the present disclosure can also include an elastomer. For example, a composition can include 5% to 75% elastomer by weight of the composition. Suitable elastomers include, for example, diene elastomers.

“Diene elastomer” can be an elastomer resulting at least in part (homopolymer or copolymer) from diene monomers (monomers bearing two double carbon-carbon bonds, whether conjugated or not).

A diene elastomer can be “highly unsaturated,” resulting from conjugated diene monomers, which have a greater than 50% molar content of units.

According to one aspect, each diene elastomer has a glass transition temperature (Tg) from −75° C. to −40° C. A diene can be a styrenebutadiene copolymer, natural polyisoprene, synthetic polyisoprene having a cis-1,4 linkage content greater than 95%, styrene/butadiene/isoprene terpolymer, or a mixture of these elastomers. According to one aspect, each diene elastomer has a glass transition temperature (Tg) from −75° C. to −40° C., or each diene elastomer has a Tg from −110° C. to −75° C., such as from −100° C. to −80° C., and is selected from polybutadienes having a cis-1,4 linkage content greater than 90% and isoprene/butadiene copolymers comprising butadiene units in an amount equal to or greater than 50%.

In another aspect, each diene elastomer having a Tg from −75° C. to −40° C. is selected from the group consisting of natural polyisoprenes and synthetic polyisoprenes having a cis-1,4 linkage content greater than 95%, and each diene elastomer having a Tg from −110° C. to −75° C. is a polybutadiene having a cis-1,4 linkage content greater than 90%.

In at least one embodiment, the composition comprises a blend of the diene elastomer(s) having a Tg from −75° C. to −40° C. and the diene elastomer(s) having a Tg from −110° C. to −75° C.

In at least one aspect, the composition includes a blend of at least one of the polybutadienes having a cis-1,4 linkage content greater than 90% with at least one of the natural or synthetic polyisoprenes (having a cis-1,4 linkage content greater than 95%).

In another aspect, the composition includes a blend of at least one of the polybutadienes having a cis-1,4 linkage content greater than 90% with at least one of the terpolymers of styrene, isoprene and butadiene.

These diene elastomers can be classified into two categories: “essentially unsaturated” or “essentially saturated”. The term “essentially unsaturated” is understood to mean generally a diene elastomer resulting at least in part from conjugated diene monomers having a level of units of diene origin (conjugated dienes) which is greater than 15% (mol %); thus it is that diene elastomers such as butyl rubbers or copolymers of dienes and of alpha-olefins of EPDM type do not come within the preceding definition and can in particular be described as “essentially saturated” diene elastomers (low or very low level of units of diene origin, less than 15%). In the category of “essentially unsaturated” diene elastomers, the term “highly unsaturated” diene elastomer is understood to mean in particular a diene elastomer having a level of units of diene origin (conjugated dienes) which is greater than 50%.

Given these definitions, the term diene elastomer capable of being used herein is understood more particularly to mean: (a) a homopolymer obtained by polymerization of a conjugated diene monomer having from 4 to 12 carbon atoms; (b) a copolymer obtained by copolymerization of one or more conjugated dienes with one another or with one or more vinylaromatic compounds having from 8 to 20 carbon atoms; (c) a ternary copolymer obtained by copolymerization of ethylene and of an alpha-olefin having 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene; (d) a copolymer of isobutene and of isoprene (butyl rubber) and also the halogenated versions, in particular chlorinated or brominated versions, of this type of copolymer.

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The copolymers can include from 99% to 20% by weight of diene units and from 1% to 80% by weight of vinylaromatic units. The elastomers may have any microstructure which depends on the polymerization conditions used, in particular on the presence or absence of a modifying and/or randomizing agent and on the amounts of modifying and/or randomizing agent employed. The elastomers can, for example, be block, random, sequential or microsequential elastomers and can be prepared in dispersion or in solution; they can be coupled and/or star-branched or also functionalized with a coupling and/or star-branching or functionalization agent. Mention may be made, for coupling to carbon black, for example, of functional groups comprising a C—Sn bond or aminated functional groups, such as benzophenone, for example.

The following are suitable: polybutadienes, in particular those having a content (molar %) of 1,2-units of from 4% to 80% or those having a content (molar %) of cis-1,4-units of greater than 80%, polyisoprenes, butadiene/styrene copolymers and in particular those having a Tg (glass transition temperature, measured according to Standard ASTM D3418) of from 0° C. to −70° C. and more particularly from −10° C. to −60° C., a styrene content of from 5% to 60% by weight and more particularly from 20% to 50%, a content (molar %) of 1,2-bonds of the butadiene part of from 4% to 75% and a content (molar %) of trans-1,4-bonds of from 10% to 80%, butadiene/isoprene copolymers, in particular those having an isoprene content of from 5% to 90% by weight and a Tg of −40° C. to −80° C., or isoprene/styrene copolymers, in particular those having a styrene content of from 5% to 50% by weight and a Tg of from −25° C. to −50° C. In the case of butadiene/styrene/isoprene copolymers, those having a styrene content of from 5% to 50% by weight and more particularly of from 10% to 40%, an isoprene content of from 15% to 60% by weight and more particularly from 20% to 50%, a butadiene content of from 5% to 50% by weight and more particularly of from 20% to 40%, a content (molar %) of 1,2-units of the butadiene part of from 4% to 85%, a content (molar %) of trans-1,4-units of the butadiene part of from 6% to 80%, a content (molar %) of 1,2-plus 3,4-units of the isoprene part of from 5% to 70% and a content (molar %) of trans-1,4-units of the isoprene part of from 10% to 50%, and more generally a butadiene/styrene/isoprene copolymer having a Tg of from −20° C. to −70° C., are suitable.

The diene elastomer chosen from the group of the highly unsaturated diene elastomers of polybutadienes (abbreviated to “BR”), synthetic polyisoprenes (IR), natural rubber (NR), butadiene copolymers, isoprene copolymers or mixture(s) of these elastomers. Such copolymers are may be chosen from the group of butadiene/styrene copolymers (SBR), isoprene/butadiene copolymers (BIR), isoprene/styrene copolymers (SIR), isoprene/butadiene/styrene copolymers (SBIR), or combination(s) thereof.

In at least one embodiment, the diene elastomer is predominantly (i.e., for more than 50 wt %) an SBR, whether an SBR prepared in emulsion (“ESBR”) or an SBR prepared in solution (“SSBR”), or an SBR/BR, SBR/NR (or SBR/IR), BR/NR (or BR/IR) or also SBR/BR/NR (or SBR/BR/IR) blend (mixture). In the case of an SBR (ESBR or SSBR) elastomer, use is made in particular of an SBR having a moderate styrene content, for example of from 20% to 35% by weight, or a high styrene content, for example from 35 to 45%, a content of vinyl bonds of the butadiene part of from 15% to 70%, a content (molar %) of trans-1,4-bonds of from 15% to 75% and a Tg of from −10° C. to −55° C.; such an SBR can advantageously be used as a mixture with a BR which may have more than 90% (molar %) of cis-1,4-bonds.

The term “isoprene elastomer” is understood to mean, in a known way, an isoprene homopolymer or copolymer, in other words a diene elastomer chosen from the group consisting of natural rubber (NR), synthetic polyisoprenes (IR), the various copolymers of isoprene and the mixtures of these elastomers. Mention will in particular be made, among isoprene copolymers, of isobutene/isoprene copolymers (butyl rubber IM), isoprene/styrene copolymers (SIR), isoprene/butadiene copolymers (BIR) or isoprene/butadiene/styrene copolymers (SBIR). This isoprene elastomer can be natural rubber or a synthetic cis-1,4-polyisoprene. For example, among these synthetic polyisoprenes, of the polyisoprenes having a level (molar %) of cis-1,4-bonds of greater than 90%, such as still of greater than 98%.

According to still another aspect, the rubber composition includes a blend of one or more “high Tg” diene elastomer exhibiting a Tg of from −70° C. to 0° C. and of one or more “low Tg” diene elastomer exhibiting a Tg of from −110° C. to −80° C., such as from −100° C. to −90° C. The high Tg elastomer can be chosen from the group of S-SBRs, E-SBRs, natural rubber, synthetic polyisoprenes (exhibiting a level (molar %) of cis-1,4-structures such as cis-1,4-structures of greater than 95%), BIRs, SIRS, SBIRs and the mixtures of these elastomers. The low Tg elastomer can include butadiene units according to a level (molar %) at least equal to 70%. The elastomer can include a polybutadiene (BR) exhibiting a level (molar %) of cis-1,4-structures of greater than 90%.

According to another embodiment of the present disclosure, the rubber composition comprises, for example, from 30 to 100 phr, such as from 50 to 100 phr (parts by weight per hundred parts of total elastomer), of a high Tg elastomer as a blend with 0 to 70 phr, such as from 0 to 50 phr, of a low Tg elastomer. According to another example, the composition includes, for the whole of the 100 phr, one or more SBR(s) prepared in solution.

According to another embodiment of the present disclosure, the diene elastomer of the composition according to the present disclosure comprises a blend of a BR (as low Tg elastomer) exhibiting a level (molar %) of cis-1,4-structures of greater than 90% with one or more S-SBRs or E-SBRs (as high Tg elastomer(s)).

The compositions described herein can include a single diene elastomer or a mixture of several diene elastomers, it being possible for the diene elastomer or elastomers to be used in combination with any type of synthetic elastomer other than a diene elastomer, indeed even with polymers other than elastomers, for example thermoplastic polymers.

The compositions can include from 5 or 10 wt % to 15 or 20 or 25 wt %, by weight of the composition of the propylene-ethylene-diene terpolymer which is a propylene-α-olefin elastomer. Such elastomers are described in, for example, U.S. Pat. Nos. 7,390,866 and 8,013,093, and are sold under such names as Vistamaxx™ Tafmer™, and Versify™. Generally, these are random polypropylene copolymers having from 5 to 25 wt % ethylene or butene-derived comonomer units having limited isotactic sequences to allow for some level of crystallinity, the copolymers in some embodiments, having a weight average molecular weight of from 10,000 or 20,000 g/mole to 100,000 or 200,000 or 400,000 g/mole and a melting point (DSC) of less than 110 or 100° C.

In at least one embodiment, the tire tread composition does not include 4 to 20 wt % of a polyolefin-polybutadiene block-copolymer, wherein the polyolefin-polybutadiene block-copolymer is a block copolymer having the general formula: PO-XL-fPB; where “PO” is a polyolefin block having a weight average molecular weight within the range from 1000 to 150,000 g/mol, the “fPB” is a functionalized polar polybutadiene block having a weight average molecular weight of from 500 to 30,000 g/mol, and “XL” is a crosslinking moiety that covalently links the PO and fPB blocks; and wherein the Maximum Energy Loss (Tangent Delta) of the immiscible polyolefin domain is a temperature within the range from −30° C. to 10° C.

In some embodiments, a styrenic copolymer in a composition is a styrene-butadiene block copolymer “rubber.” Such rubbers may have from 10 or 15 or 20 wt % to 30 or 25 or 40 wt % styrene derived units, by weight of the block copolymer, and from 30 or 40 or 45 wt % to 55 or 60 or 65 wt % vinyl groups.

### Tires

A tire can be any suitable tire, such as a rubber tire having an outer (visible) rubber sidewall layer where the outer sidewall layer includes a composition of the present disclosure.

The tire can be built, shaped, molded to include the outer sidewall rubber sidewall layer and cured by various methods which will be readily apparent to those having skill in such art.

The prepared tire of the present disclosure can be conventionally shaped and cured by methods known to those having skill in such art.

### Inorganic Fillers

Because a need for filler to be introduced to the ultimate tire product is reduced or eliminated using methods of the present disclosure, the reduction or absence of filler in the tire product provides improved wear resistance, for example reduced or eliminated cracking initiation and propagation, of the tire product (tire tread).

The term “filler” as used herein refers to any material that is used to reinforce or modify physical properties of a composition (as a tire product), impart certain processing properties, or reduce cost of a composition.

Examples of inorganic filler include calcium carbonate, clay, mica, silica, silicates, talc, titanium dioxide, alumina, zinc oxide, starch, wood flour, or combination(s) thereof. The fillers may be any size and range, for example in the tire industry, from 0.0001 μm to 100 μm.

As used herein, the term “silica” is meant to refer to any type or particle size silica or another silicic acid derivative, or silicic acid, processed by solution, pyrogenic, or the like methods, including untreated, precipitated silica, crystalline silica, colloidal silica, aluminum or calcium silicates, fumed silica, and the like. Precipitated silica can be conventional silica, semi-highly dispersible silica, or highly dispersible silica. A filler can be commercially available by Rhodia Company under the trade name ZEOSIL™ Z1165 or ZEOSIL™ 1165 MP.

In some embodiments, a composition (as a tire product) includes, per 100 parts by weight of rubber (phr), about 100 to about 140 phr silica. In another embodiment, a composition (as a tire product) includes, per 100 parts by weight of rubber (phr), about 110 to about 130 phr of silica. In a further embodiment, a composition includes, per 100 parts by weight of rubber (phr), about 115 to about 120 phr silica.

### Additional Aspects

The present disclosure provides, among others, the following aspects, each of which may be considered as optionally including any alternate aspects.

Clause 1. A method of forming a composition comprising a functionalized polymer, the method comprising:
forming a polymer melt in a melt feeder, the melt feeder coupled with an extruder;
introducing the polymer melt from the melt feeder to the extruder at a first location of the extruder;
extruding the polymer melt through a plurality of mixing zones of the extruder via a plurality of intermeshing screws disposed within the extruder; and
introducing a coupling agent to the extruder at a second location of the extruder.
   Clause 2. The method of Clause 1, further comprising introducing an additive to the extruder at a third location of the extruder located at an initial ¼ to ¾ length of the extruder and located upstream of the second location.
   Clause 3. The method of Clauses 1 or 2, further comprising removing air or moisture from the extruder via a vent stuffer coupled with the extruder at a fourth location of the extruder, the fourth location located at an initial ⅛ to ½ length of the extruder.
   Clause 4. The method of any of Clauses 1 to 3, further comprising providing an extrudate from the extruder to a twin screw melt pump to form the composition and removing the composition from the twin screw melt pump.
   Clause 5. The method of any of Clauses 1 to 4, wherein the coupling agent is introduced as a solid to the extruder at the second location of the extruder.
   Clause 6. The method of any of Clauses 1 to 5, wherein:
the first location is located at an initial 1/16 to ¼ length of the extruder, and
the second location is located at an initial ¼ to ¾ length of the extruder.
   Clause 7. The method of any of Clauses 1 to 6, wherein extruding the polymer melt through the extruder is performed at an average extruder temperature of about 200° F. to about 650° F.
   Clause 8. The method of any of Clauses 1 to 7, wherein extruding the polymer melt through the extruder is performed by rotating a screw of the plurality of screws at a rate of about 275 rpm to about 375 rpm.
   Clause 9. The method of any of Clauses 1 to 8, wherein extruding the polymer melt through the extruder is performed by rotating the screw at a total effective mixing intensity of the screw of about 450 to about 600.
   Clause 10. The method of any of Clauses 1 to 9, wherein extruding the polymer melt through the extruder is performed by rotating the screw at a dynamic mixing intensity of about 4,000 sec⁻¹ to about 6,500 sec⁻¹.
   Clause 11. The method of any of Clauses 1 to 10, wherein extruding the polymer melt through the extruder is performed by:
operating a first quintile of a screw of the plurality of intermeshing screws at a dynamic mixing intensity of about 600 sec⁻¹ to about 750 sec⁻¹ to provide a first mixing zone of the plurality of mixing zones;
operating a second quintile of the screw at a dynamic mixing intensity of about 600 sec⁻¹ to about 710 sec⁻¹ to provide a second mixing zone of the plurality of mixing zones;
operating a third quintile of the screw at a dynamic mixing intensity of about 500 sec⁻¹ to about 600 sec⁻¹ to provide a third mixing zone of the plurality of mixing zones;
operating a fourth quintile of the screw at a dynamic mixing intensity of about 2,000 sec⁻¹ to about 2,500 sec⁻¹ to provide a fourth mixing zone of the plurality of mixing zones; and
operating a fifth quintile of the screw at a dynamic mixing intensity of about 1,300 sec⁻¹ to about 2,000 sec⁻¹ to provide a fifth mixing zone of the plurality of mixing zones.
   Clause 12. The method of any of Clauses 1 to 11, wherein extruding the polymer melt through the extruder is performed by:
operating a first quintile of a screw of the plurality of intermeshing screws at a total effective mixing intensity of about 50 to about 70 to provide a first mixing zone of the plurality of mixing zones;
operating a second quintile of the screw at a total effective mixing intensity of about 50 to about 70 to provide a second mixing zone of the plurality of mixing zones;
operating a third quintile of the screw at a total effective mixing intensity of about 40 to about 60 to provide a third mixing zone of the plurality of mixing zones;
operating a fourth quintile of the screw at a total effective mixing intensity of about 180 to about 220 to provide a fourth mixing zone of the plurality of mixing zones; and
operating a fifth quintile of the screw at a total effective mixing intensity of about 130 to about 170 to provide a fifth mixing zone of the plurality of mixing zones.
   Clause 13. The method of any of Clauses 1 to 12, wherein the extruder is operated at an output capacity of about 3,000 kg/h to about 6,000 kg/h.
   Clause 14. The method of any of Clauses 1 to 13, wherein forming the polymer melt in the melt feeder comprises:
introducing a solid polymer into a hopper comprising a plurality of grinders;
operating the grinders to grind the solid polymer into particles; and
introducing the particles into an auger barrel comprising:
   a screw rotatably positioned in the auger barrel, and
   a plurality of heating jackets disposed around the auger barrel to heat the particles and form the polymer melt.
      Clause 15. The method of any of Clauses 1 to 14, wherein the polymer melt has a temperature of about 300° F. to about 650° F. when introducing the polymer melt from the melt feeder to the extruder.
      Clause 16. The method of any of Clauses 1 to 15, wherein the polymer melt has a temperature of about 350° F. to about 600° F. when introducing the polymer melt from the melt feeder to the extruder.
      Clause 17. The method of any of Clauses 1 to 16, further comprising providing the extrudate through the melt pump by operating a screw disposed within the melt pump, the screw having a diameter of about 60 mm to about 200 mm, wherein operating the screw comprises rotating the screw at a speed of about 15 min⁻¹ to about 160 min⁻¹.
      Clause 18. The method of any of Clauses 1 to 17, wherein operating the melt pump is performed at an output torque of about 700 Nm to about 28,300 Nm.
      Clause 19. The method of any of Clauses 1 to 18, wherein operating the melt pump is performed at a pressure of about 100 bar to about 500 bar.
      Clause 20. The method of any of Clauses 1 to 19, wherein the extrudate is substantially free of inorganic filler.
      Clause 21. The method of any of Clauses 1 to 20, wherein the extrudate comprises 0 phr to about 5 phr inorganic filler.
      Clause 22. The method of any of Clauses 1 to 21, wherein the polymer melt comprises a polymer selected from the group consisting of a butyl rubber, an ethylene-propylene-diene terpolymer, a poly(isobutylene-co-para-methylstyrene-co-isoprene) terpolymer, and combination(s) thereof.
      Clause 23. The method of any of Clauses 1 to 22, wherein the composition comprises a functionalized polymer selected from the group consisting of a functionalized butyl rubber, a functionalized ethylene-propylene-diene terpolymer, functionalized poly(isobutylene-co-para-methylstyrene-co-isoprene) terpolymer, and combination(s) thereof.
      Clause 24. The method of any of Clauses 1 to 23, wherein the coupling agent is selected from the group consisting of a sulfur-based coupling agent, a silane coupling agent, an organic peroxide-based coupling agent, an inorganic coupling agent, a polyamine coupling agent, a resin coupling agent, a sulfur compound-based coupling agent, an oxime-nitrosamine-based coupling agent, and combination(s) thereof.
      Clause 25. The method of any of Clauses 1 to 24, wherein the coupling agent is a silane coupling agent.
      Clause 26. The method of any of Clauses 1 to 25, wherein the silane coupling agent is selected from the group consisting of:
bis[3-(triethoxysilyl)propyl]polysulfide,
bis[3-(methyl diethoxysilyl)propyl]polysulfide,
bis[3-(octyl diethoxysilyl)propyl]polysulfide,
bis[3-(diethoxy octyloxysilyl)propyl]polysulfide,
bis[3-(ethoxy dioctyloxysilyl)propyl]polysulfide,
bis[8-(triethoxysilyl)octyl]polysulfide,
bis[8-(methyl diethoxysilyl)octylpolysulfide, and
combination(s) thereof.
   Clause 27. The method of any of Clauses 1 to 26, wherein the polymer melt comprises a diene elastomer selected from the group consisting of a polybutadiene, a polyisoprene, a butadiene/styrene copolymer, an isoprene/butadiene copolymer, an isoprene/styrene copolymer, an isoprene/butadiene/styrene copolymer, or combination(s) thereof.
   Clause 28. An extruder system, comprising:
an extruder having a first end, a second end, and a plurality of ports disposed along the extruder;
a rubber feeder coupled with the first end of the extruder or a first port of the plurality of ports;
a vent stuffer coupled with a second port of the plurality of ports;
an additive source coupled with a third port of the plurality of ports;
a coupling agent source coupled with a fourth port of the plurality of ports; and
a melt pump coupled with the second end of the extruder.

### Examples

### Product Characterization

### Sample Work Up Procedure:

Weigh approximately 2.5 g of the polymer sample obtained from the reactive extrusion process as described above and record exact mass to 4 decimal places. Place the polymer sample in a stainless steel tea infuser mesh strainer with a lid on the top, then place inside a 500 mL glass jar. Add 190 mL of heptane and allow the polymer sample to immerse in heptane for 3-5 days with the jar lid. This step is carried out to extract the soluble polymer fraction into the heptane solution, while trapping any swollen insoluble polymer fraction in tea infuser strainer. After soaking for 3-5 days, the tea infuser strainer is carefully pulled out and rinsed with fresh heptane. The solvent is then removed by slow evaporation in the fume hood until the polymer solution is reduced to approximately 20-30 mL. An equivalent volume of acetone is then added to the concentrated solution to coagulate the polymer from the solvent. The polymer sample is then washed with fresh aliquot of acetone until the wash fraction appears clear. The polymer is dried in a vacuum oven and the final mass is obtained and recorded to 4 decimal places.

As expected for grafted product, both samples tested (JCWGA1204 and JCWGA1105) were found to be completely soluble in heptane. Polymer characterization was done using sulfur analysis and ¹H-NMR spectroscopy.

### ¹H-NMR Test Method:

In a glass vial, add 50 mg of sample and ˜1 mL of 99.8% CDCl₃ with 0.03% (v/v) TMS. Place on wrist action shaker until completely dissolved ˜2 hours. Transfer the solution to a new NMR tube (using Deuterotubes BORO400-5-7) ensuring that all of the sample is dissolved and there are no solids remaining. Run the PROTON experiment on the Bruker 500 MHz NMR locked onto CDCl₃ as the solvent and using the standard parameters below:
NUC: 1H
DS: 2
NS:16
TD0: 1
AQ: 3.27 seconds
SW: 19.99 ppm or 10,000 Hz
Zg30 is a 30° pulse; 5 mm probe, 16 scans, 1 s delay, 500 MHz.

Analyze the spectra using MestReNova software. Perform a manual phase correction and baseline correction before integration.

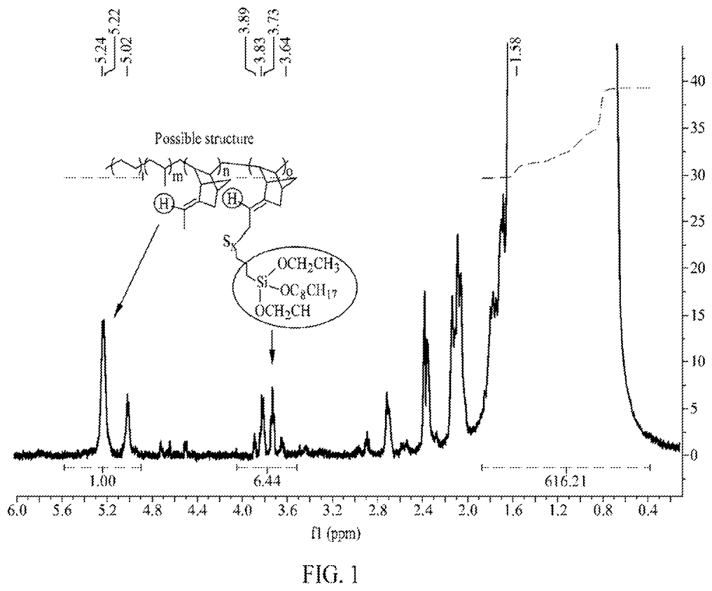

FIG. 1 is an NMR Spectrum of the silane-functionalized EPDM rubber. For the silane grafted EPDM sample, the peaks at 3.64 to 3.89 ppm correspond to the Si—OCH₂— protons and the peaks at 5.02 and 5.23 ppm correspond to the olefinic protons.

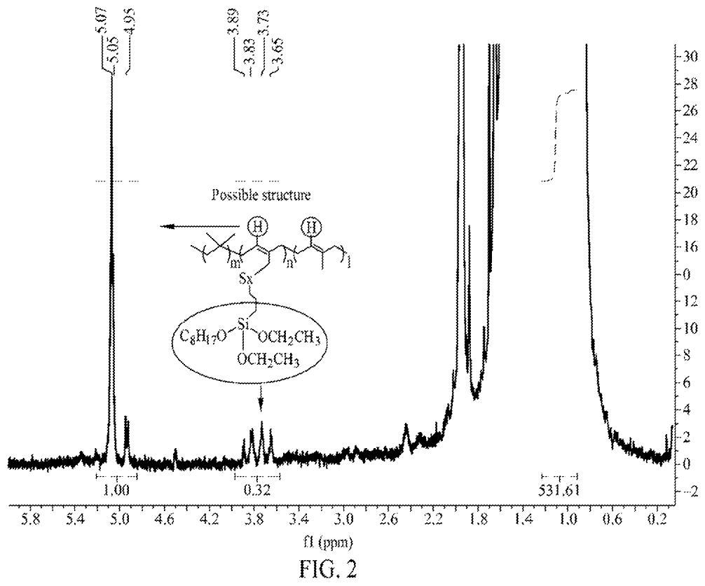

FIG. 2 is an NMR Spectrum of the silane-functionalized butyl rubber. For the silane grafted Butyl rubber sample, the peaks at 3.65 to 3.89 ppm correspond to the Si—OCH₂— protons and the peaks at 4.95 and 5.07 ppm correspond to the olefinic protons.

Table 5 illustrates the grafted amounts of rubber samples.

TABLE 5

| Sample | mol % grafted | wt % grafted |
|---|---|---|
| EPDM | 0.073 | 38% |
| Butyl rubber | 0.06 | 27% |

### Sulfur Analysis Test Method:

Sulfur analysis was conducted on the LECO SC832DR high-performance sulfur/carbon analyzer. Samples were combusted in the furnace in the presence of oxygen gas and the SO₂, CO and CO₂ gases produced pass through a duel-range, solid-state IR cell inside the instrument, which provides the sulfur and carbon content. A calibration method is set up using 1% and 3% S standards purchased from LECO Corp.

Before analyzing the samples, a blank correction was performed followed by running the 3% S standard to ensure the instrument is operating as expected. All experiments are performed in triplicates. The final results are reported as the average of the triplicate runs.

Table 6 illustrates sulfur content of rubber samples.

TABLE 6

| | % S before | % S after | |
|---|---|---|---|
| | coagulation | coagulation | % S |
| Sample | (Total sulfur) | (Bound sulfur) | utilization |
| EPDM | 0.3372 | 0.1248 | 37 |
| Butyl rubber | 0.3514 | 0.0871 | 25 |

*%S utilization = % Bound sulfur/% Total sulfur * 100

Overall, the present disclosure provides extrusion methods and extruder systems capable of providing functionalized polymers with a high degree of functionalization, which may be used as tire tread compounds (additives) that provide good wet traction without increasing rolling resistance and tread wear to tire tread.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All numerical values within the detailed description herein are modified by “about” the indicated value, and take into account experimental error and variations that would be expected by a person having ordinary skill in the art.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

We claim:

1. A method of forming a composition comprising a functionalized polymer, the method comprising:
forming a polymer melt in a melt feeder, the melt feeder coupled with an extruder;
introducing the polymer melt from the melt feeder to the extruder at a first location of the extruder;
extruding the polymer melt through a plurality of mixing zones of the extruder via a plurality of intermeshing screws disposed within the extruder; and
introducing a coupling agent to the extruder at a second location of the extruder.

2. The method of claim 1, further comprising introducing an additive to the extruder at a third location of the extruder located at an initial ¼ to ¾ length of the extruder and located upstream of the second location.

3. The method of claim 2, further comprising removing air or moisture from the extruder via a vent stuffer coupled with the extruder at a fourth location of the extruder, the fourth location located at an initial ⅛ to ½ length of the extruder.

4. The method of claim 1, further comprising providing an extrudate from the extruder to a twin screw melt pump to form the composition and removing the composition from the twin screw melt pump.

5. The method of claim 1, wherein the coupling agent is introduced as a solid to the extruder at the second location of the extruder.

6. The method of claim 1, wherein:
the first location is located at an initial 1/16 to ¼ length of the extruder, and
the second location is located at an initial ¼ to ¾ length of the extruder.

7. The method of claim 1, wherein extruding the polymer melt through the extruder is performed at an average extruder temperature of about 200° F. to about 650° F.

8. The method of claim 7, wherein extruding the polymer melt through the extruder is performed by rotating a screw of the plurality of screws at a rate of about 275 rpm to about 375 rpm.

9. The method of claim 8, wherein extruding the polymer melt through the extruder is performed by rotating the screw at a total effective mixing intensity of the screw of about 450 to about 600.

10. The method of claim 8, wherein extruding the polymer melt through the extruder is performed by rotating the screw at a dynamic mixing intensity of about 4,000 sec⁻¹ to about 6,500 sec⁻¹.

11. The method of claim 1, wherein extruding the polymer melt through the extruder is performed by:
operating a first quintile of a screw of the plurality of intermeshing screws at a dynamic mixing intensity of about 600 sec⁻¹ to about 750 sec⁻¹ to provide a first mixing zone of the plurality of mixing zones;
operating a second quintile of the screw at a dynamic mixing intensity of about 600 sec⁻¹ to about 710 sec⁻¹ to provide a second mixing zone of the plurality of mixing zones;
operating a third quintile of the screw at a dynamic mixing intensity of about 500 sec⁻¹ to about 600 sec⁻¹ to provide a third mixing zone of the plurality of mixing zones;
operating a fourth quintile of the screw at a dynamic mixing intensity of about 2,000 sec⁻¹ to about 2,500 sec⁻¹ to provide a fourth mixing zone of the plurality of mixing zones; and
operating a fifth quintile of the screw at a dynamic mixing intensity of about 1,300 sec⁻¹ to about 2,000 sec⁻¹ to provide a fifth mixing zone of the plurality of mixing zones.

12. The method of claim 1, wherein extruding the polymer melt through the extruder is performed by:
operating a first quintile of a screw of the plurality of intermeshing screws at a total effective mixing intensity of about 50 to about 70 to provide a first mixing zone of the plurality of mixing zones;
operating a second quintile of the screw at a total effective mixing intensity of about 50 to about 70 to provide a second mixing zone of the plurality of mixing zones;
operating a third quintile of the screw at a total effective mixing intensity of about 40 to about 60 to provide a third mixing zone of the plurality of mixing zones;
operating a fourth quintile of the screw at a total effective mixing intensity of about 180 to about 220 to provide a fourth mixing zone of the plurality of mixing zones; and
operating a fifth quintile of the screw at a total effective mixing intensity of about 130 to about 170 to provide a fifth mixing zone of the plurality of mixing zones.

13. The method of claim 1, wherein the extruder is operated at an output capacity of about 3,000 kg/h to about 6,000 kg/h.

14. The method of claim 1, wherein forming the polymer melt in the melt feeder comprises:
introducing a solid polymer into a hopper comprising a plurality of grinders;
operating the grinders to grind the solid polymer into particles; and
introducing the particles into an auger barrel comprising:
a screw rotatably positioned in the auger barrel, and
a plurality of heating jackets disposed around the auger barrel to heat the particles and form the polymer melt.

15. The method of claim 1, wherein the polymer melt has a temperature of about 300° F. to about 650° F. when introducing the polymer melt from the melt feeder to the extruder.

16. The method of claim 15, wherein the polymer melt has a temperature of about 350° F. to about 600° F. when introducing the polymer melt from the melt feeder to the extruder.

17. The method of claim 4, further comprising providing the extrudate through the melt pump by operating a screw disposed within the melt pump, the screw having a diameter of about 60 mm to about 200 mm, wherein operating the screw comprises rotating the screw at a speed of about 15 min⁻¹ to about 160 min⁻¹.

18. The method of claim 4, wherein the extrudate is substantially free of inorganic filler.

19. The method of claim 4, wherein the extrudate comprises 0 phr to about 5 phr inorganic filler.

20. The method of claim 19, wherein the polymer melt comprises a polymer selected from the group consisting of a butyl rubber, an ethylene-propylene-diene terpolymer, a poly(isobutylene-co-para-methylstyrene-co-isoprene) terpolymer, and combination(s) thereof.

21. The method of claim 20, wherein the composition comprises a functionalized polymer selected from the group consisting of a functionalized butyl rubber, a functionalized ethylene-propylene-diene terpolymer, a functionalized poly(isobutylene-co-para-methylstyrene-co-isoprene) terpolymer, and combination(s) thereof.

22. The method of claim 1, wherein the coupling agent is selected from the group consisting of a sulfur-based coupling agent, a silane coupling agent, an organic peroxide-based coupling agent, an inorganic coupling agent, a polyamine coupling agent, a resin coupling agent, a sulfur compound-based coupling agent, an oxime-nitrosamine-based coupling agent, and combination(s) thereof.

23. The method of claim 1, wherein the coupling agent is a silane coupling agent.

24. The method of claim 23, wherein the silane coupling agent is selected from the group consisting of:
bis[3-(triethoxysilyl)propyl]polysulfide,
bis[3-(methyl diethoxysilyl)propyl]polysulfide,
bis[3-(octyl diethoxysilyl)propyl]polysulfide,
bis[3-(diethoxy octyloxysilyl)propyl]polysulfide,
bis[3-(ethoxy dioctyloxysilyl)propyl]polysulfide,
bis[8-(triethoxysilyl)octyl]polysulfide,
bis[8-(methyl diethoxysilyl)octylpolysulfide, and
combination(s) thereof.

25. The method of claim 1, wherein the polymer melt comprises a diene elastomer selected from the group consisting of a polybutadiene, a polyisoprene, a butadiene/styrene copolymer, an isoprene/butadiene copolymer, an isoprene/styrene copolymer, an isoprene/butadiene/styrene copolymer, or combination(s) thereof.
